(19) United States
(12) Patent Application Publication
(10) Pub. No.: US 2015/0262093 A1
(43) Pub. Date: Sep. 17, 2015

(54) METHOD AND APPARATUS FOR DISTRIBUTED GENERATOR LIFECYCLE MANAGEMENT

(71) Applicant: Enphase Energy, Inc., Petaluma, CA (US)

(72) Inventors: Leesa Lee, Sausalito, CA (US); Ilen Zazueta-Hall, Sebastopol, CA (US)

(21) Appl. No.: 14/691,266

(22) Filed: Apr. 20, 2015

Related U.S. Application Data
(63) Continuation of application No. 12/925,705, filed on Oct. 27, 2010.
(60) Provisional application No. 61/279,844, filed on Oct. 27, 2009.

(51) Int. Cl. G06Q 10/06

(52) U.S. Cl. CPC G06Q 10/0631

(57) ABSTRACT

A method and apparatus for distributed generator (DG) planning. In one embodiment, the apparatus comprises a computing system, comprising at least one processor, for generating a plurality of different user-interactive interfaces for visually depicting a plurality of DG lifecycle stages of at least one DG, wherein each user-interactive interface of the plurality of different user-interactive interfaces respectively displays manipulatable information regarding: A) managing a sales lead for a potential DG; B) designing the potential DG; C) managing installation information for installation of a DG based on the potential DG; D) activating, following completion of the installation of the DG, the DG; and E) monitoring and displaying at least one performance characteristic of the DG; wherein each user-interactive interface of the plurality of different user-interactive interfaces is selectable from a dashboard to display the manipulatable information related to each DG lifecycle stage in the plurality of DG lifecycle stages.

### CROSS-REFERENCE TO RELATED APPLICATIONS

This application is a continuation of co-pending U.S. patent application Ser. No. 12/925,705, filed Oct. 27, 2010, which claims benefit of U.S. provisional patent application Ser. No. 61/279,844, filed Oct. 27, 2009. Each of the aforementioned patent applications is herein incorporated in its entirety by reference.

### BACKGROUND OF THE INVENTION

1. Field of the Invention

Embodiments of the present disclosure relate generally to distributed generators (DGs) and, more particularly, to a method and system for planning DGs.

2. Description of the Related Art

Use of distributed generators (DGs) to produce energy from renewable resources is steadily gaining commercial acceptance due to the rapid depletion of existing fossil fuels and the increasing costs of current methods of generating power. One such type of DG may be utilized within a solar power system, where each DG in the solar power system is comprised of photovoltaic (PV) modules that convert solar energy received from the sun into a direct current (DC). A power converter then converts the DC current from the PV modules into a direct current (DC) or an alternating current (AC), and the resultant power generated by the DGs may be stored for later use, used to run appliances at a home or business, or may be sold to the commercial power company.

Deployment of DGs for generating solar power is becoming increasingly widespread and involves a wide range of tasks leading up to the deployment. For example, sales leads must be managed, each potential DG system must be individually designed based on requirements specific to the particular installation, such as budget, location, and the like, and customer proposals must be generated. Such activities as well as associated information must be coordinated and tracked in order to efficiently manage each DG installation.

Therefore, there is a need in the art for a system for efficiently planning a DG system installation.

### SUMMARY OF THE INVENTION

Embodiments of the present invention generally relate to distributed generator (DG) planning, deployment, and operation as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a system for managing and planning distributed generators (DGs) in accordance with one or more embodiments of the present invention;

FIG. 2 is a block diagram of a DG management and planning system 108 in accordance with one or more embodiments of the present invention;

FIGS. 3A-3V depict a series of display screens for managing and planning installation of DGs in accordance with one or more embodiments of the present invention, where FIG. 3A depicts a dashboard screen, FIG. 3B depicts a systems overview window, FIG. 3C depicts a site overview screen, FIG. 3D depicts a roof space screen, FIG. 3E depicts a roof space screen, FIG. 3F depicts an array size screen, FIG. 3G depicts a budget/cost screen, FIG. 3H depicts the budget/cost screen comprising a simple payback window, FIG. 3I depicts the budget/cost screen comprising an IRR window, FIG. 3J depicts a components screen, FIG. 3K depicts a checklist screen, FIG. 3L depicts an initial proposal screen, FIG. 3M depicts a site evaluation screen, FIG. 3N depicts a display of a site evaluation worksheet, FIG. 3O depicts a component selection screen, FIG. 3P depicts an array layout screen, FIG. 3Q depicts a design planning window depicting a plurality of roof face profiles, FIG. 3R depicts a design planning window that displays a plurality of obstruction profiles, FIG. 3S depicts a design planning window that displays a plurality of shading profiles, FIG. 3T depicts a design planning window that displays a plurality of PV module placement profiles, FIG. 3U depicts a budget calculator screen, and FIG. 3V depicts a proposal screen;

FIG. 4, which continues on FIG. 4A, is a flow diagram of a method for DG system management and planning in accordance with one or more embodiments of the present invention;

FIG. 5, which continues on FIG. 5A, depicts an alternative embodiment of a dashboard screen;

FIG. 6 depicts one embodiment of a create array window; and

FIG. 7 depicts one embodiment of an array builder window.

### DETAILED DESCRIPTION

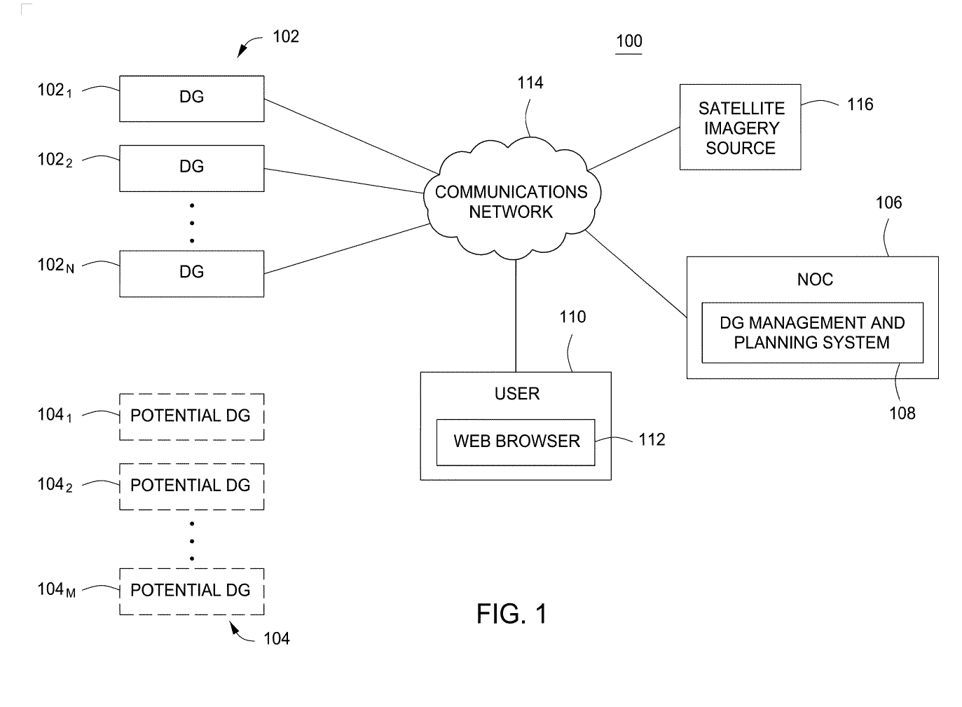

FIG. 1 is a block diagram of a system 100 for managing and planning distributed generators (DGs) in accordance with one or more embodiments of the present invention. The system 100 comprises a plurality of distributed generators (DGs) 102₁, 102₂, . . . 102ₙ, (hereinafter, DGs 102), a plurality of potential DGs 104₁, 104₂, . . . , 104ₘ, (hereinafter, potential DGs 104), a network operations center (NOC) 106, a user 110, and a satellite imagery source 116, all communicatively coupled via a communications network 114, e.g., the Internet.

The DGs 102 are DGs that are either in the process of being installed and turned-up for operation or are fully installed and operational. Each DG 102, once fully installed and operational, generates power from one or more renewable resource, such as solar energy, wind energy, hydroelectric energy, and the like. The generated power may be used to operate appliances in a home or business, coupled to a commercial power grid and sold to the commercial power utility, or a combination of both. Additionally or alternatively, the generated power may be stored for later use (e.g., utilizing batteries, heated water, hydro pumping, H₂O-to-hydrogen conversion, or the like).

In some embodiments, a DG 102 is comprised of a plurality of solar panels arranged in groups as solar arrays, where each solar panel is comprised of one or more power converters coupled to one or more photovoltaic (PV) modules in a one-to-one correspondence. The power converters may be DC-DC converters, DC-AC converters, or some combination of DC-DC and DC-AC converters. In one or more alternative embodiments, multiple PV modules may be coupled to a single power converter (i.e., a centralized power converter).

The potential DGs 104 represent possible future DG systems that are currently in a planning phase. Such a planning phase may range from an earliest indication of a sales lead for a DG system through a final DG system proposal made to a customer and a subsequent signed contract for the DG system.

The NOC 106 is a centralized operations management center for the DGs 102 and 104. The NOC 106 comprises a DG management and planning system 108 accessible by one or more users via a website, such as the user 110 utilizing a conventional web browser 112. In accordance with one or more embodiments of the present invention, the DG management and planning system 108 provides operative control and monitoring of the existing DGs 102, as well as planning functions for the potential DGs 104. Such planning functions, described in greater detail below, may comprise designing a DG for a specific location and may use satellite imagery obtained from a satellite imagery source 116, such as GOOGLE EARTH or MICROSOFT VIRTUAL EARTH, as well as map imagery (e.g., obtained from an Internet source, such as YAHOO! MAPS), and/or hybrid (satellite and map) imagery; in some embodiments, such satellite and/or map imagery may be retrieved from the corresponding source for use by the DG management and planning system 108 in real time. In some alternative embodiments, the DG management and planning system 108 may reside in a separate location from the NOC 106 and be communicatively coupled to the NOC 106, and/or the functions for managing existing DGs 102 and the functions for planning potential DGs 104 may reside in separate systems.

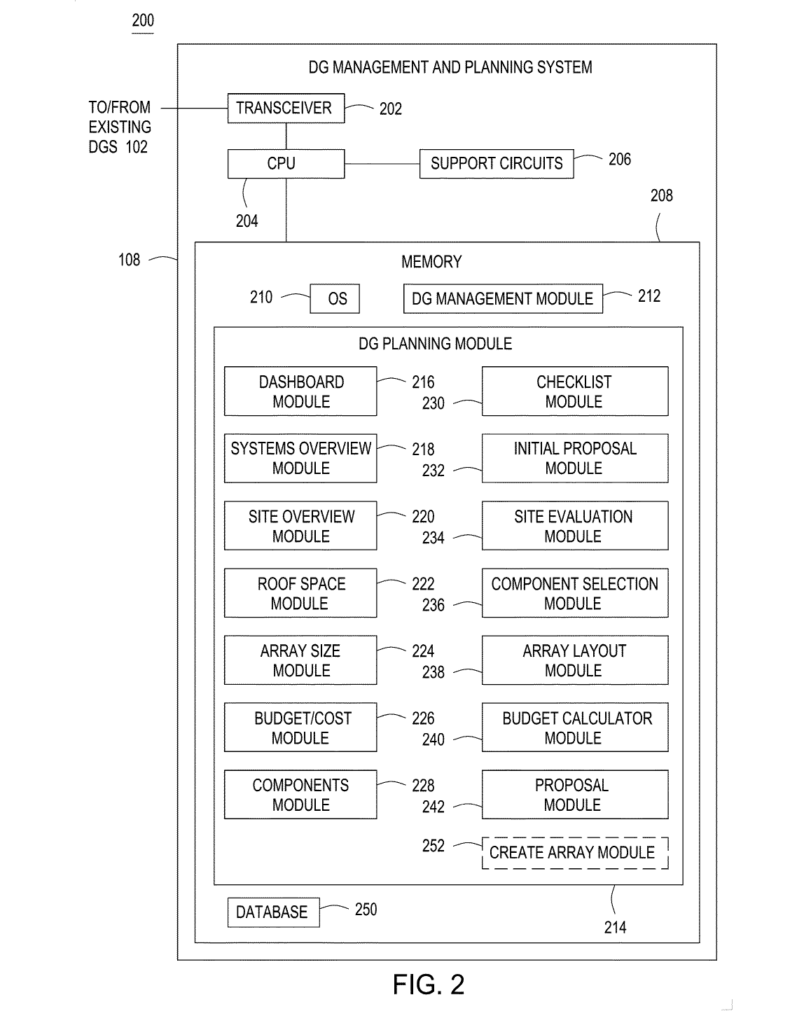

FIG. 2 is a block diagram of a DG management and planning system 108 in accordance with one or more embodiments of the present invention. The DG management and planning system 108 comprises a central processing unit (CPU) 204 coupled to a transceiver 202, support circuits 206, and a memory 208. Additionally, the transceiver 202 is coupled to the DGs 102 via the communications network 114 for bi-directional communication with the DGs 102, e.g., for sending operative commands to the DGs 102, receiving performance data from the DGs 102, and the like. The transceiver 202 may utilize wireless or wired techniques for such communication. The DG management and planning system 108 may be implemented using a general purpose processor that, when executing particular software, becomes a specific purpose processor for performing various embodiments of the present invention.

The CPU 204 may comprise one or more conventionally available microprocessors. Alternatively, the CPU 204 may include one or more application specific integrated circuits (ASICs). The support circuits 206 are well known circuits used to promote functionality of the CPU 204 and may include, but are not limited to, a cache, power supplies, clock circuits, buses, network cards, input/output (I/O) circuits, and the like.

The memory 208 may comprise random access memory, read only memory, removable disk memory, flash memory, and various combinations of these types of memory. The memory 208 is sometimes referred to as main memory and may, in part, be used as cache memory or buffer memory. The memory 208 generally stores the operating system (OS) 210 of the DG management and planning system 108. The OS 210 may be one of a number of commercially available operating systems such as, but not limited to, SOLARIS from SUN Microsystems, Inc., AIX from IBM Inc., HP-UX from Hewlett Packard Corporation, LINUX from Red Hat Software, Windows 2000 from Microsoft Corporation, and the like.

The memory 208 may store various forms of application software, such as a DG management module 212 and a DG planning module 214. Additionally, the memory 208 may store a database 250 for storing data related to the present invention.

The DG management module 212 provides operative control of the existing DGs 102, for example, by generating signals to control the operation of individual components within the DGs 102. Additionally, the DG management module 212 provides monitoring for the DGs 102, for example, by receiving and processing performance data from the DGs 102 for display and/or long term storage in the database 250.

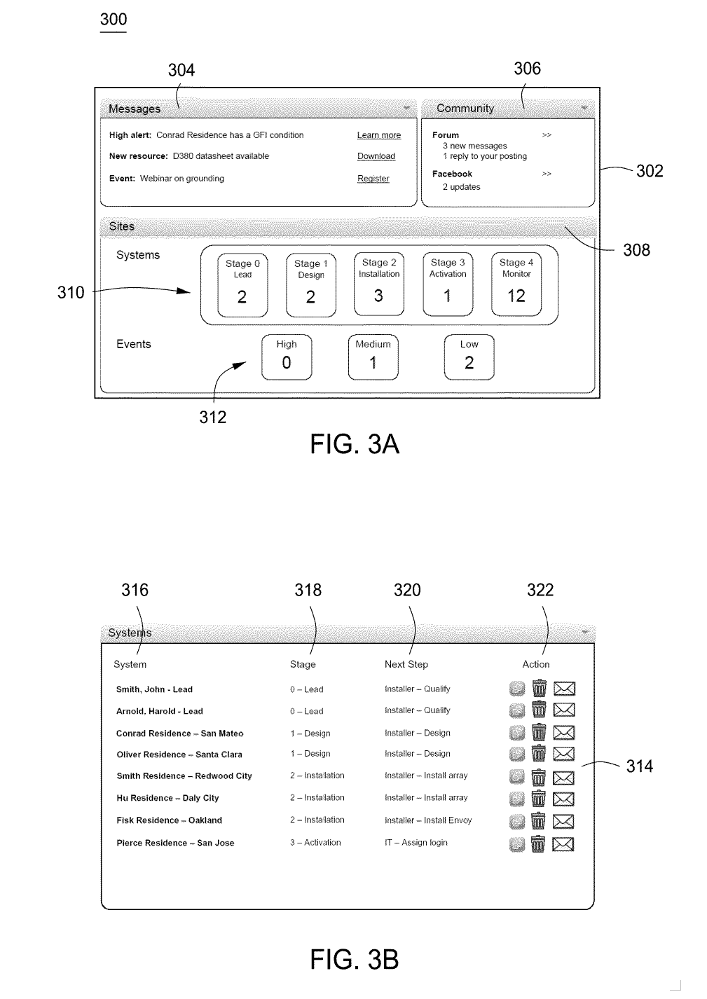

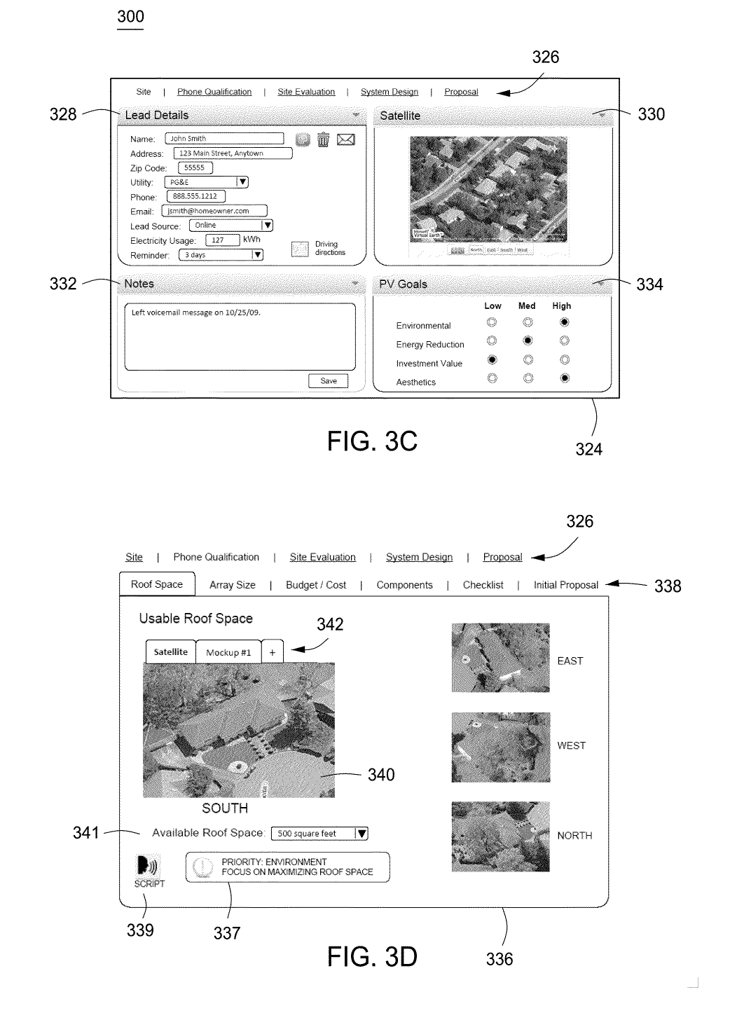

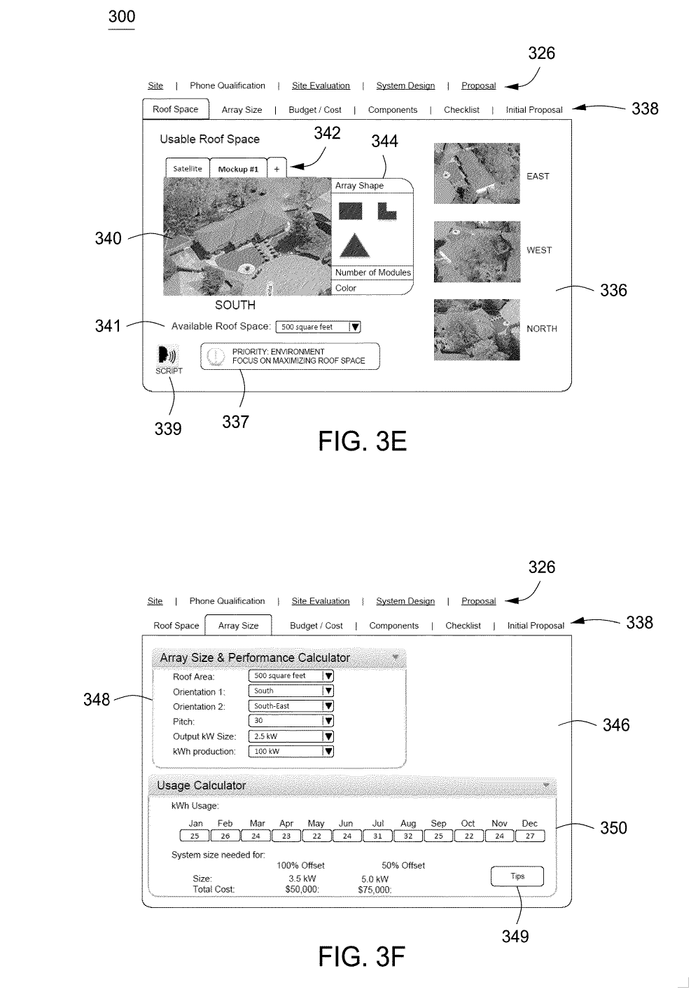

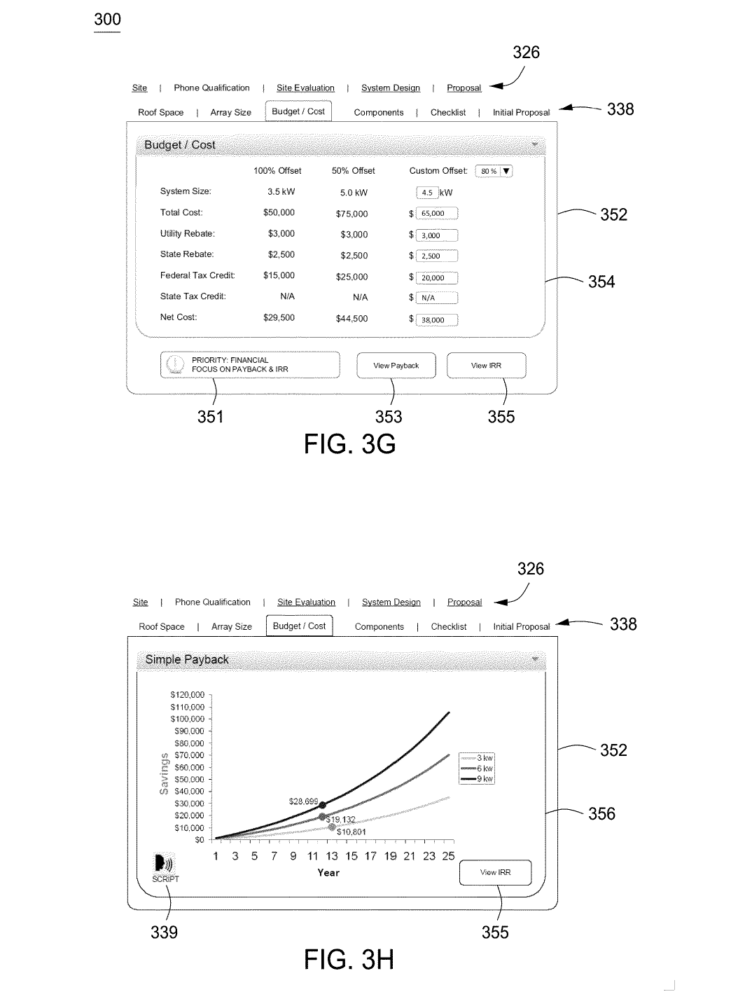

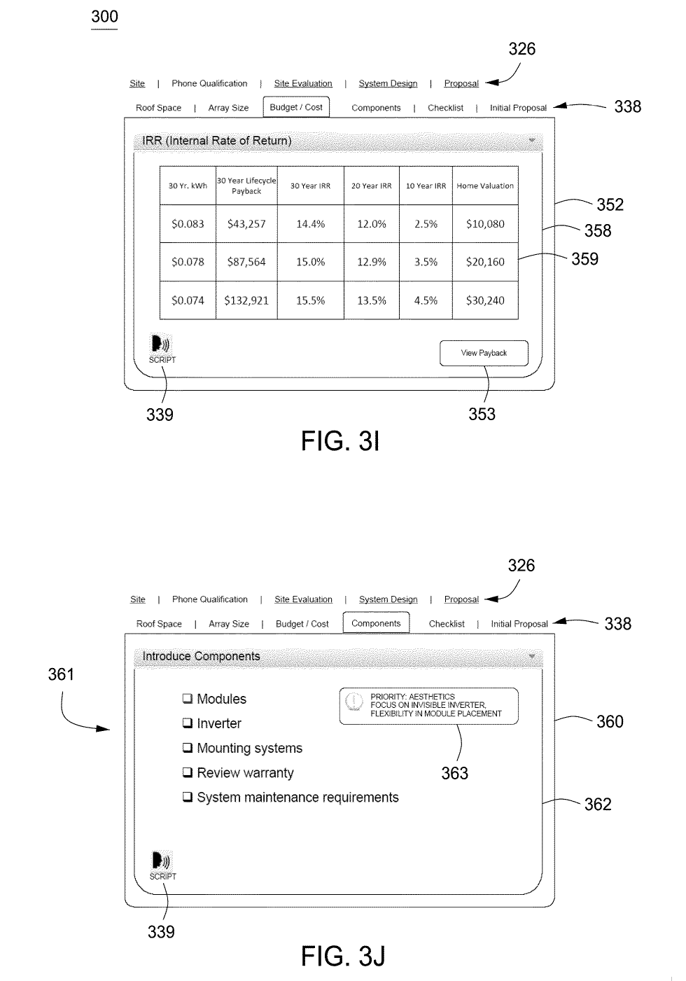

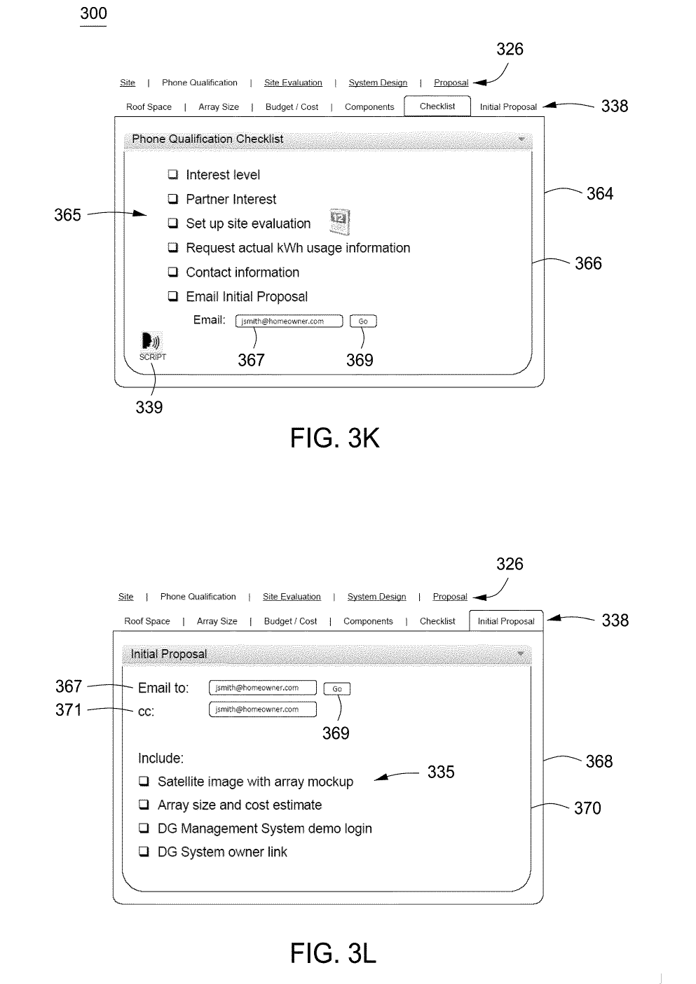

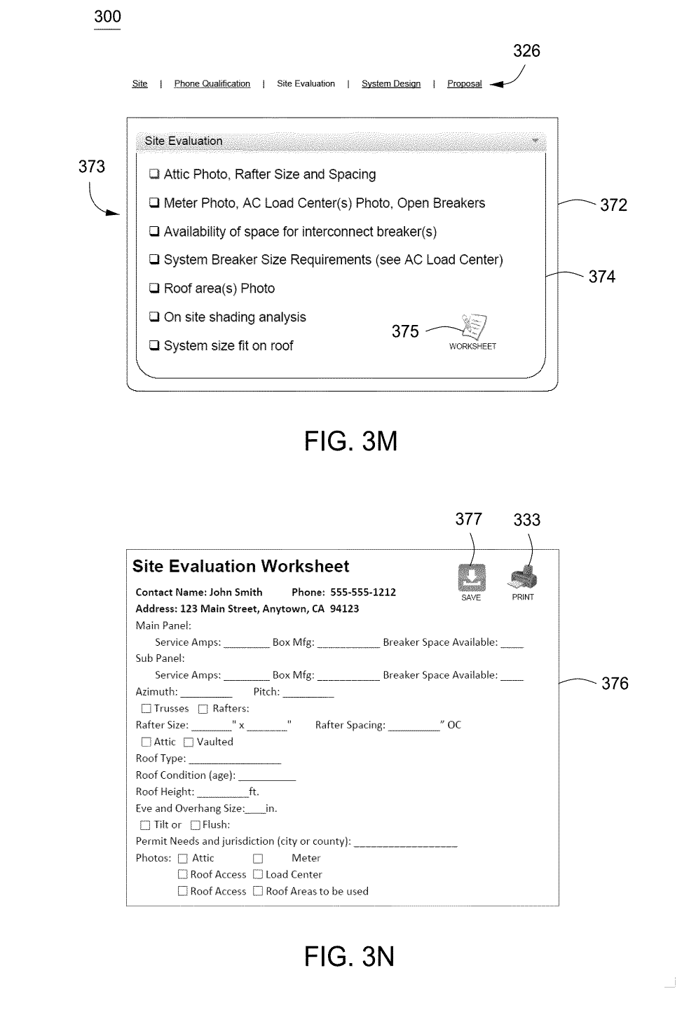

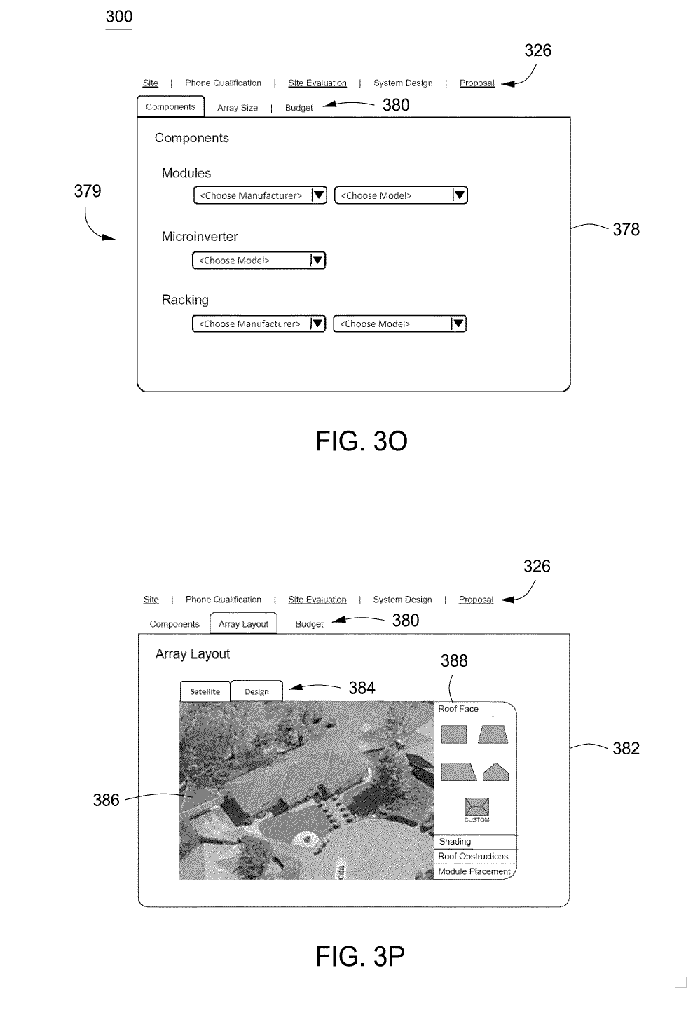

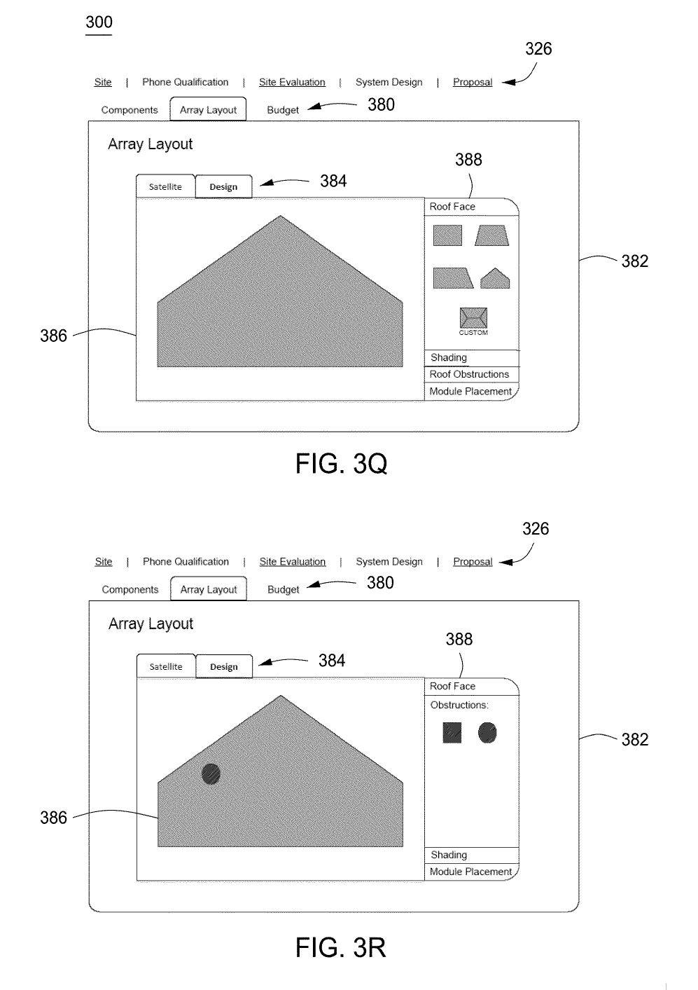

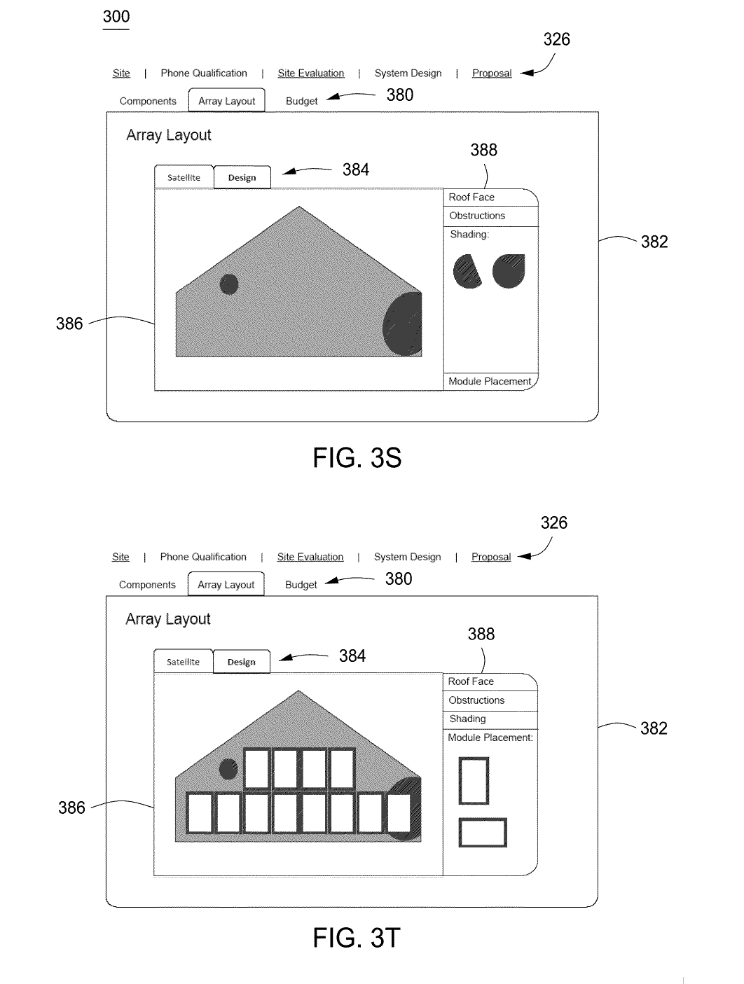

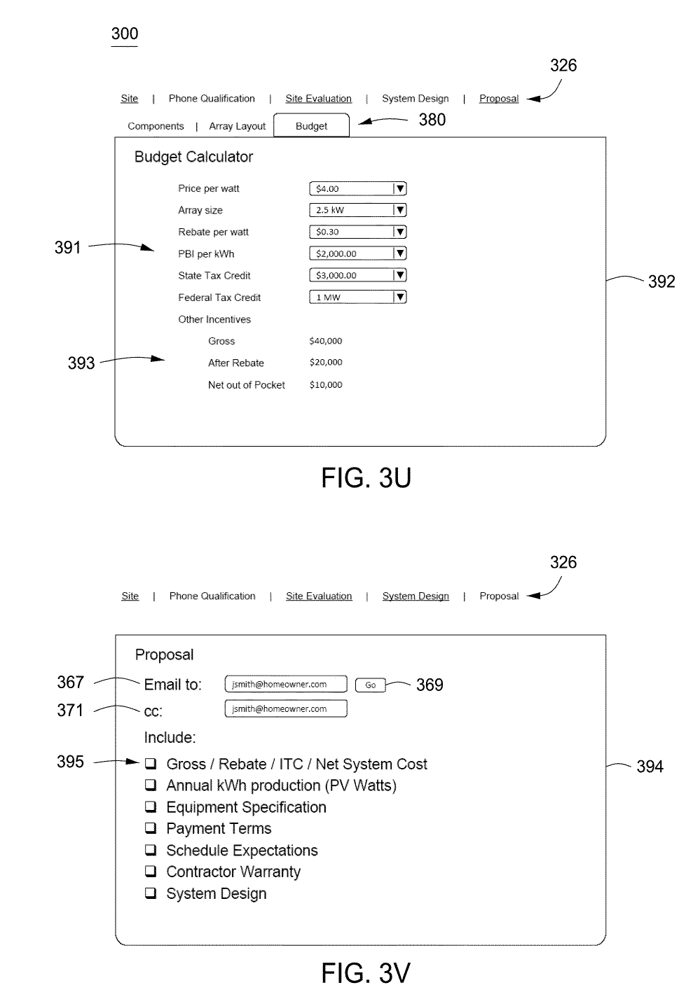

The DG planning module 214 provides functionality to plan, design, and track status of the potential DGs 104, for example via a series of display screens described in detail with respect to FIG. 3, from the earliest indication of a possible DG sale up to deployment of a committed DG (e.g., through a signed contract with a customer). Such functionality enables a user to expedite the sales qualification process, streamline the creation of sales proposals, create professional-quality customer-facing proposals, reduce errors and inconsistencies in solar array design, and support new staff during the training period.

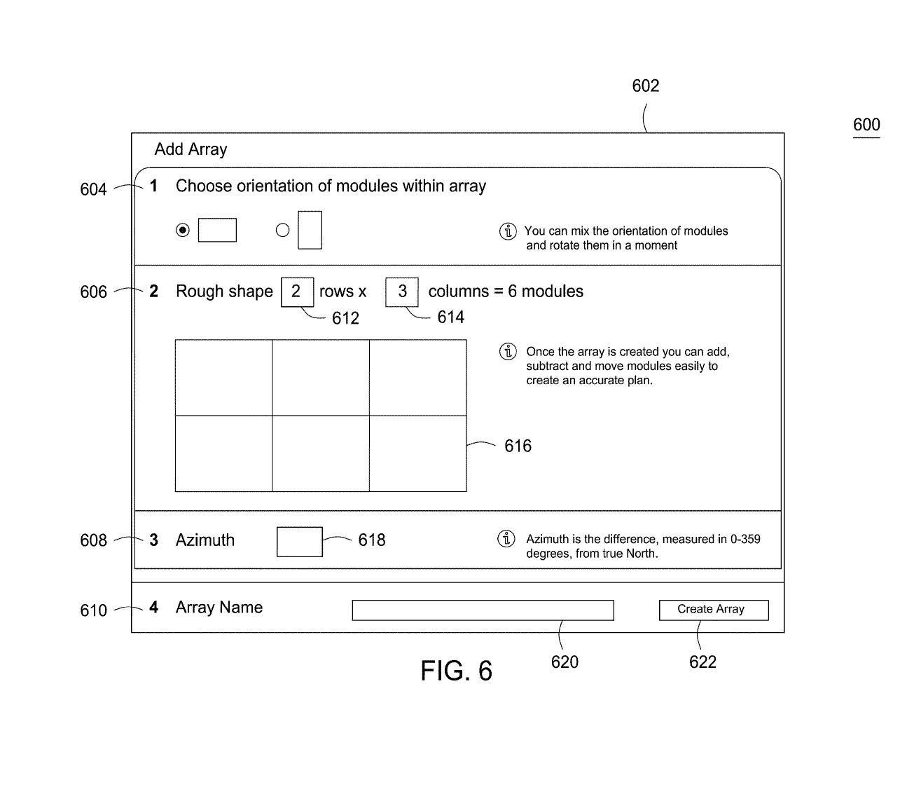

The DG Planning Module 214 contains dashboard module 216, systems overview module 218, site overview module 220, roof space module 222, array size module 224, budget/cost module 226, components module 228, checklist module 230, initial proposal module 232, site evaluation module 234, component selection module 236, array layout module 238, budget calculator module 240, and proposal module 242; in some embodiments, the DG Planning Module 214 may additionally contain a create array module 252 (shown as a dashed box in FIG. 2). Each module comprises software code—source or object code—that when executed by the CPU 204 provides the functionality described below with respect to FIGS. 3, 4, and 5, and, in some embodiments, FIG. 6. In one embodiment, execution of the software code of a module enables a general purpose computer to operate as a specific purpose computer.

In some embodiments, the database 250 comprises satellite imagery data, obtained from the satellite imagery source 116, and/or map imagery (e.g., obtained from an Internet source) needed for graphics and images generated by the DG planning module 214; in other embodiments, such satellite and/or map imagery may not be stored within the database 250 and may be retrieved from the corresponding source for use in real time. Additionally, the database 250 may store user-generated data generated via the DG planning module 214, such as draft DG designs, notes pertaining to a potential DG 104, and the like.

In some other embodiments, the DG management module 212 and the DG planning module 214 may reside within different systems. For example a DG management system may comprise a CPU coupled to a transceiver, support circuits, and a memory that comprises the DG management module 212; and a separate DG planning system may comprise a CPU coupled to a transceiver, support circuits, and a memory that comprises the DG planning module 214.

FIGS. 3A-3V depict a series of display screens 300 for planning installation of DGs in accordance with one or more embodiments of the present invention. The display screens 300 are generated by the DG planning module 214 upon a successful login to a website (e.g., a DG management and planning website) by the user 110. In some embodiments, one or more portions of the display screens 300 may be generated in conjunction with the DG management module 212; for example, one or more of the display screens 300 may display information pertaining to managing existing DGs 102. Although the display screens 300 described below are directed to planning installation of a solar power DG, the DG planning module 214 may additionally or alternatively generate analogous display screen for planning other types of DGs, such as wind farms, hydroelectric systems, or the like.

FIG. 3A depicts a dashboard screen 302 comprising a message window 304, a community window 306, and a sites window 308. The dashboard screen 302 is an interface to the executable dashboard module 216 that, when executed, provides the user 110 the ability to manage daily work tasks. The message window 304, community window 306, and sites window 308 may each be collapsed or expanded by clicking on a suitable icon.

The message window 304 displays messages for the user 110, such as alerts on issues requiring attention, information messages on news and resources, corporate happenings, and the like. The message window 304 may additionally display user-selectable options to provide additional information for some or all of the displayed messages, e.g., links to obtain more information, download data, register for events, and the like.

The community window 306 displays community-related information, such as links to peer-to-peer forums and social networking, status of messages, postings, updates, and the like. In some alternative embodiments, the dashboard screen 302 may additionally or alternatively display a summary of metrics, such as a comparison of the user's average DG installation times compared to average DG installation times of other employees.

The sites window 308 displays a summary of site statistics for the DGs 102 and the potential DGs 104. In some embodiments, the sites window 308 displays thumbnail summaries 310 indicating a number of DGs 102 and potential DGs 104 at each of a plurality of DG lifecycle stages for DG planning, deployment, and operation. In some embodiments, the following DG lifecycle stages may be depicted: Stage 0 (Lead), Stage 1 (Design), Stage 2 (Installation), Stage 3 (Activation), and Stage 4 (Monitor). Additionally, the sites window 308 may display thumbnail summaries 312 indicating a number of DGs 102 experiencing each of a plurality of performance alarm or event severities, such as the number of DGs 102 having high, medium, and/or low severity alarms or events at the current time.

The user 110 may select a thumbnail 310 to obtain additional information pertaining to DGs 102 and potential DGs 104 at a particular lifecycle stage, such as potential DGs 104 in the design stage. The user 110 may select a thumbnail 312 to obtain additional information pertaining to DGs 102 experiencing a particular severity level of monitoring condition, such as DGs 102 experiencing high-severity alarms. Alternatively, the user 110 may select an overview of all or a subset of the DGs 102 and/or the potential DGs 104.

FIG. 3B depicts a systems overview window 314. The systems overview window 314 is an interface to the executable systems overview module 218 that, when executed, provides the user 110 the ability to determine, for one or more DGs 102 and/or potential DGs 104, a current lifecycle stage and any next steps needed. In some embodiments, the systems overview window 314 may be viewed by selecting one or more of the thumbnails 310. The systems overview window 314 may be collapsed or expanded by clicking on a suitable icon.

The systems overview window 314 comprises a systems column 316 for displaying an identification, such as a customer name and location, for one or more DGs 102 and/or potential DGs 104; a stage column 318 for displaying the lifecycle stage of each DG system displayed; and a next step column 320 for displaying a next needed action for implementing each DG system displayed as well as a responsible personnel (e.g., “Installer—Qualify”, “Installer—Design”, “Installer—Install Array”, “Installer—Install Envoy”, “Enphase—Assign Login”, and the like). Additionally, the systems overview window 314 comprises an actions column 322. The actions column 322 may display icons and/or links for one or more actions a user may take regarding a particular DG system, such as an envelope icon for generating an email, a trash can icon for disposing of information, a clipboard icon for opening a document, a window icon for opening an additional window, and the like.

FIG. 3C depicts a site overview screen 324. The site overview screen 324 may be displayed by selecting a “site” category from a plurality of selectable DG planning categories 326 displayed, for example, horizontally along the top of the display screen. The DG planning categories 326 may comprise categories such as site, phone qualification, site evaluation, system design, and proposal. The user 110 may select any of the DG planning categories 326 in order to view a corresponding screen. Generally, the DG planning categories 326 are displayed along with the display screens and windows described below so that the user 110 may navigate among the various screens/windows associated with each planning category. In some embodiments, the DG planning categories 326 may be hidden, for example by clicking an appropriate icon.

The site overview screen 324 is an interface to the executable site overview module 220 that, when executed, provides the user 110 the ability to manage and track various high-level information related to the potential DG 104. In some other embodiments, the site overview screen 324 may display high-level information pertaining to a particular DG 102. The site overview screen 324 displays high-level information pertaining to a particular potential DG 104 and comprises a lead details window 328, a satellite window 330, a PV goals window 334, and a notes window 332. Each of the windows within the site overview screen 324 may be collapsed or expanded, for example by clicking on an appropriate icon.

The lead details window 328 displays a plurality of fields that contain details pertaining to a DG sales lead (i.e., a potential customer), such as the customer's name, address, utility provider, phone contact, email contact, a lead source, and electricity usage, as well as a reminder for contacting the customer within a certain a timeframe. In some embodiments, an automatic notification to the user 110 (e.g., an email) may be triggered based on the timeframe in the reminder field. The user 110 may enter new data into one or more of the displayed fiends, and/or one or more of the fields may be automatically populated with data from the database 250. The user 110 may enter or change data in any of the fields using well known data entry methods (e.g., manual entry, importing data, drop-down menus, and the like), and the user 110 may save the data in the fields at any time.

The lead details window 328 further displays an icon for linking to driving directions to the customer's location; such driving directions may be stored in the database 250 or obtained via existing Internet sources, such as MAPQUEST.

The satellite window 330 displays satellite imagery of the potential DG's location obtained, for example, from the database 250 or via existing Internet sources, such as GOOGLE EARTH or MICROSOFT VIRTUAL EARTH. The satellite imagery may be automatically obtained based on data entered in one or more fields within the lead details screen 328, such as the address. Such satellite imagery provides an overhead view of the potential DG's location so that the user 110 can initially assess a portion of the requirements for DG installation. The satellite window 330 displays options for the user 110 to select a variety of satellite views of the location, such as a view from a particular direction (i.e., north, south, east, and west), rotating a displayed view, zooming in or out of a displayed view, panning across a displayed view, and the like. In some embodiments, the satellite window 330 may display map imagery and/or hybrid (satellite and map) imagery.

The notes window 332 provides an interface for the user 110 to document information pertaining to the potential DG 104, e.g., notes on discussions held with the customer, attempts to contact the customer, and the like. The notes window 332 may also display an icon for saving added information. The PV goals window 334 displays a plurality of attributes related to a DG and the priority of each attribute from the customer's perspective. For example, the PV goals window 334 may display a rating (e.g., low, medium, high) indicating the customer's priority for DG attributes such as environmental, energy reduction, investment value, and aesthetic aspects of the DG deployment.

FIG. 3D depicts a roof space screen 336. The roof space screen 336 may be displayed by selecting the “phone qualification” category from the DG planning categories 326 and a “roof space” tab from a plurality of qualification tabs 338 displayed when the phone qualification category is selected. The qualification tabs 338 allow the user 110 to select particular screens related to a phone qualification of the potential DG 104. In some embodiments, the qualification tabs 338 include the roof space tab (for displaying the roof space screen 336), an array size tab, a budget/cost tab, a components tab, a checklist tab, and an initial proposal tab. In other embodiments, the qualification tabs 338 may comprise other tabs for displaying other screens related to a potential DG phone qualification.

The roof space screen 336 is an interface to the executable roof space module 222 that, when executed, provides the user 110 the ability to assess usable space for installing a potential DG 104. In particular, the roof space screen 336 displays satellite imagery of the potential DG location for planning a rooftop DG deployment. For example, overhead views (e.g., north, south, east, and west views) of usable roof space allows the user 110 to assess a potential solar power system installation. In alternative embodiments, an alternative screen may display satellite imagery to assist the user 110 in assessing deployment of DGs at locations other than rooftops (such as building walls, open fields, or other suitable locations) and/or for assessing deployment of other types of DGs, such as DGs comprising wind turbines, hydroelectric systems, or the like. The roof space screen 336 may additional or alternatively display map imagery and/or hybrid (satellite and map) imagery.

The roof space screen 336 may display a plurality of different satellite views (e.g., north/south/east/west views) that each may be expanded in size. A particular satellite view may be displayed as a main usable roof view 340 for the user 110 to generate one or more initial proposals (“mockups”) of the potential DG installation. The main usable roof view 340 may have a plurality of associated tabs 342 (e.g., “satellite”, “mockup #1”, and the like) to select between displaying the unaltered satellite view, such as the unaltered south satellite view shown in FIG. 3D, and the mockups.

The roof space screen 336 additionally displays an available roof space field 341 for entering, for example via a drop-down menu, an available roof space size (e.g., available square footage); a priority field 337 that indicates the highest customer priorities for the DG installation and corresponding areas of focus (e.g., for a customer considering the environment to be a high priority, the user 110 should focus on maximizing available roof space); and a script icon 339 for displaying and/or playing an audio version of related “talking points” for use in customer interactions.

FIG. 3E depicts a roof space screen 336 in which one of the tabs 342 has been selected for creating a first mockup (i.e., “mockup #1”). A mockup planning window 344 is displayed in conjunction with the main usable roof space view 340 for the user 110 to select from boiler-plate content, such as profiles depicting basic array shapes, number of photovoltaic (PV) modules, color of PV modules, and the like, to generate the mockup. Additionally or alternatively, the user 110 may utilize a create array window 602, described below with respect to FIG. 6, for creating an array for the mockup. The roof space screen 336 (e.g., the mockup planning window 344), or another of the screens 300, may comprise an icon for the user 110 to access the create array window 602. The user 110 may save the first mockup as desired.

FIG. 3F depicts an array size screen 346. The array size screen 346 may be displayed by selecting the “phone qualification” category from the DG planning categories 326 and subsequently selecting the “array size” tab from the qualification tabs 338.

The array size screen 346 is an interface to the executable array size module 224 that, when executed, provides the user 110 the ability to physically size a potential DG 104. The array size screen 346 comprises an array size and performance calculator window 348 and a usage calculator window 350; each window may be collapsed or expanded by clicking on a suitable icon. The array size and performance calculator window 348 displays a plurality of fields for documenting site-specific DG design parameters, such as roof area, orientations, pitch, output power size, power production, and the like. The user 110 may enter new data into one or more of the displayed fields, and/or one or more of the fields may be automatically populated with data from the database 250. The user 110 may enter or change data in any of the fields using well known data entry methods (e.g., manual entry, importing data, drop-down menus, and the like), and the user 110 may save the data in the fields at any time. In other embodiments, the array size screen 346 may display additional and/or alternative fields, such as fields for sizing potential DG installations at locations other rooftops.

The usage calculator window 350 displays customer power usage per-month, for example as entered by the user 110, and displays computed system size and cost estimates to offset utility power needs or a percentage of the utility power needs In some embodiments, the usage calculator window 350 may provide system size and cost estimates to achieve 100% offset and 50% offset. Additionally or alternatively, system size and cost estimates to achieve other offset percentages may be provided; in some embodiments, the user 110 may be able to select and/or enter one or more desired offset percentages. The usage calculator window 350 may additionally display a tip icon 349 for displaying tips.

FIG. 3G depicts a budget/cost screen 352. The budget/cost screen 352 may be displayed by selecting the “phone qualification” category from the DG planning categories 326 and subsequently selecting the “budget/cost” tab from the qualification tabs 338.

The budget/cost screen 352 is an interface to the executable budget/cost module 226 that, when executed, provides the user 110 the ability to determine financial incentives and costs (i.e., a financial size) associated with a potential DG 104 based on a possible size of the potential DG 104. The budget/cost screen 352 comprises a budget/cost summary window 354 for displaying financial costs and savings associated with a potential DG 104 based on the installation size. For example, for a potential DG 104, costs and savings for installations sized to achieve various utility power offset percentages, such as 100% offset, 50% offset, and a user-customizable offset, are displayed in the budget/cost summary window 354. For each installation size, the budget/cost summary window 354 displays the corresponding customer-specific system and financial parameters, such as system size (e.g., in kilowatt-hours), total cost, utility rebate, state rebate, federal tax credit, state tax credit, and net cost. In some other embodiments, other additional and/or alternative parameters may be displayed.

The budget/cost screen 352 further comprises a priority reminder display 351 for indicating customer priorities related to the potential DG 104 and corresponding areas of focus during the DG planning (e.g., the customer places a high priority on financial aspects of the DG system and thus focus should be on payback and IRR), a view payback button 353 for selecting a display of financial payback for the customer, and a view internal rate of return (IRR) button 355 for selecting a display of the IRR for the customer.

In some embodiments, one or more of the screens shown in FIGS. 3F-3I may be generated by a separate module, such as a commercially available module manufactured by Clean Power Finance, Clean Power Research, or SolarNexus, or a similar commercially available module.

FIG. 3H depicts the budget/cost screen 352 comprising a simple payback window 356 obtained by selecting the view payback button 353 previously described. The simple payback window 356 depicts a graphical display of dollar savings per year for various sized installations of a potential DG 104, for example, for each of a 3 kilowatt, 6 kilowatt, and 9 kilowatt DG. Additionally, the simple payback window 356 comprises the view IRR button 355 as well as a script icon 339 for displaying corresponding talking points for use during customer interactions.

FIG. 3I depicts the budget/cost screen 352 comprising an IRR window 358 obtained by selecting the view IRR button 355 previously described. The IRR window 358 may be expanded or collapsed by clicking on a suitable icon. The IRR window 358 comprises a tabular display 359 of IRR parameters for the various sized installations of a potential DG 104. The tabular display 359 comprises columns for each of the IRR parameters, such as 30 year kilowatt hours, 30 year lifecycle payback, 30 year IRR, 20 year IRR, 10 year IRR, and home valuation. The corresponding data for each of the various sized installations is presented along the rows of the tabular display 359. Additionally, the IRR window 358 comprises the view payback button 353 as well as the script icon 339. In some other embodiments, the tabular display 359 may display additional and/or alternative IRR parameters.

The roof space screen 336, the array size screen 346, and the budget/cost screen 352 allow the user 110 to size a potential DG 104 both physically and financially.

FIG. 3J depicts a components screen 360. The components screen 360 may be displayed by selecting the “phone qualification” category from the DG planning categories 326 and subsequently selecting the “components” tab from the qualification tabs 338.

The components screen 360 is an interface to the executable components module 228 that, when executed, provides the user 110 the ability to manage customer communications pertaining to components of a potential DG 104. The components screen 360 comprises an introduce components window 362 for managing customer interactions pertaining to components of the potential DG 104. The introduce components window 362 comprises a check-list display 361 of physical and logical components for the potential DG 104, such as PV modules, power converters (e.g., inverters), mounting systems, warranty information, and system maintenance requirements, and the like. The introduce components window 362 further comprises a priority reminder display 363 for indicating customer priorities related to the potential DG 104 and corresponding areas of focus during the DG planning; for example the customer places a high priority on aesthetics of the DG system and thus focus should be on invisible power converters/flexibility in module placement. Additionally, the components screen 360 comprises a script icon 339 for displaying and/or playing an audio recording of corresponding talking points for use during customer interactions.

FIG. 3K depicts a checklist screen 364. The checklist screen 364 may be displayed by selecting the “phone qualification” category from the DG planning categories 326 and subsequently selecting the “checklist” tab from the qualification tabs 338.

The checklist screen 364 is an interface to the executable checklist module 230 that, when executed, provides the user 110 the ability to manage customer communications pertaining to a potential DG 104. The checklist screen 364 comprises a phone qualification checklist window 366 comprising a checklist display 365 of topics pertaining to qualification of a DG sales lead, such as interest level, partner interest, setting up a site evaluation, requesting power usage information, customer contact information, sending an initial DG system proposal, and the like. The user 110 may “check off” each of the topics as they are addressed during the DG planning. One or more of the topics in the check-list display 365 may have an associated icon for opening an associated application; for example, a calendar icon may be displayed along with the topic for setting up a site evaluation in order to display a calendar. Additionally, the phone qualification checklist window 366 comprises an email field 367 for entering/displaying the customer's email, an icon 369 for generating an email to the customer, and the script icon 339 for displaying and/or playing an audio recording of corresponding talking points for use during customer interactions.

FIG. 3L depicts an initial proposal screen 368 that may be displayed by selecting the “phone qualification” category from the DG planning categories 326 and subsequently selecting the “initial proposal” tab from the qualification tabs 338.

The initial proposal screen 368 is an interface to the executable initial proposal module 232 that, when executed, provides the user 110 the ability to generate an initial proposal for a potential DG 104. The initial proposal screen 368 comprises an initial proposal window 370 having the email field 367 and a “cc” field 371 (i.e., a carbon copy field) for entering/displaying a first and a second email address, such as the customer's email address and any other pertinent email address, and the icon 369 for initiating an email of an initial DG proposal to be sent to the entered addresses. Additionally, the initial proposal window 370 comprises a checklist display 335 for the user 110 to select items to be included in the initial proposal, such as a satellite image with an array mockup, an array size and cost estimate, a login for a DG management system demonstration, a DG system owner link (e.g., a link to a contact responsible for the customer's DG), and the like.

FIG. 3M depicts a site evaluation screen 372 that may be displayed by selecting the “site evaluation” category from the DG planning categories 326.

The site evaluation screen 372 is an interface to the executable site evaluation module 234 that, when executed, provides the user 110 the ability to manage an evaluation of a potential DG location. The site evaluation screen 372 comprises a site evaluation window 374 having a checklist display 373 of actions to be performed when evaluating a particular site for deployment of a DG, such as obtaining a photo of an attic and determining rafter size and spacing; obtaining photos of a power meter and AC load center(s), and determining open breakers; determining availability of space for interconnect breaker(s); determining system breaker size requirements; obtaining one or more photos of the roof area; performing on-site shading analysis; determining a system size fit on the roof, and the like. The site evaluation window 374 further comprises a worksheet icon 375 for generating a detailed site evaluation worksheet display. The site evaluation window 374 may be expanded or collapsed by clicking on an appropriate icon.

FIG. 3N depicts a display of a site evaluation worksheet 376 that may be displayed by selecting the worksheet icon 375 previously described. The site evaluation worksheet 376 comprises fields for documenting information related to a potential DG location, such as a customer's name, address, and phone number, as well as a detailed list of information to be gathered and fields in which to document information obtained during an on-site evaluation of a potential location for a DG installation. Such information to be gathered and documented may include information pertaining to main and sub breaker panels (e.g., service amps, box manufacturer, breaker space available); roof azimuth and pitch; whether the roof comprises trusses and/or rafters and pertinent information (e.g., rafter size and spacing); existence of an attic and/or a vaulted roof; roof type, condition/age, height, eves, overhang size, and whether tilt or flush; permit needs and jurisdiction, and photos (e.g., attic, power meter, roof access, load center, and roof areas to be utilized). Additionally, the site evaluation worksheet 376 comprises a save icon 377 for saving a copy of the site evaluation worksheet 376 (e.g., after entering information) and a print icon 333 for printing a copy of the site evaluation worksheet 376. In some embodiments, information associated with the site evaluation worksheet 376 (such as permits/permit information, photos, and the like) may be uploaded and linked to the site evaluation worksheet 376 and/or the site evaluation window 374. Additionally, the site evaluation worksheet 376 and/or the site evaluation window 374 may comprise one or more links for obtaining site-related information (such as power usage, permit needs, jurisdiction information, and the like) from existing Internet sources.

FIG. 3O depicts a component selection screen 378 that may be displayed by selecting the “system design” category from the DG planning categories 326 and subsequently selecting a “components” tab from a plurality of design tabs 380 that are displayed when the system design category is selected. The design tabs 380 allow the user 110 to select particular screens related to a system design for the potential DG 104; in some embodiments, the design tabs 380 include a components tab (for displaying the component selection screen 378), an array layout tab, and a budget tab. In other embodiments, the design tabs 380 may have fewer or more tabs and/or tabs pertaining to other areas of a DG system design.

The component selection screen 378 is an interface to the executable component selection module 236 that, when executed, provides the user 110 the ability to manage component selection for a potential DG 104. The component selection screen 378 comprises a plurality of component fields 379. Each component field 379 comprises a drop-down menu for selecting components for the DG being planned, such as particular PV modules (e.g., a drop-down menu for selecting a PV module manufacturer and a drop-down menu for selecting a particular PV module model available from a selected manufacturer), power converters (e.g., a drop-down menu for selecting a power converter model), and racking (e.g., a drop-down menu for selecting a racking manufacturer and a drop-down menu for selecting a particular racking model available from a selected manufacturer). Alternatively, the user 110 may enter data into one or more of the component fields 379 by typing in data, importing data, or other data entry technique. The user 110 may save any of the entered data.

FIG. 3P depicts an array layout screen 382 that may be displayed by selecting the “system design” category from the DG planning categories 326 and subsequently selecting the “array layout” tab from the design tabs 380. The array layout screen 382 is an interface to the executable array layout module 238 that, when executed, provides the user 110 the ability to design a solar array layout for a potential DG 104. In other embodiments, an analogous screen may provide an interface for designing a layout for other types of DGs, such as wind farms, hydroelectric systems, and the like.

The array layout screen 382 comprises an image view 386 for the user 110 to generate one or more designs of the potential DG 104. The image view 386 may have a plurality of associated tabs (e.g., “satellite”, “design”, and the like) to select between a satellite view of the potential DG site (as depicted in FIG. 3P), a design view for designing the potential DG 104, or other views of the potential DG site (e.g., map imagery, hybrid imagery, and the like). Additionally, a displayed design planning window 388 allows the user 110 to select boiler-plate content and/or create custom content for designing the potential DG 104, such as roof shapes, shading patterns, roof obstructions, and PV module placement. Additionally or alternatively, the user 110 may utilize a create array window 602, described below with respect to FIG. 6, when designing the potential DG 104. The array layout screen 382 (e.g., the design planning window 388), or another of the screens 300, may comprise an icon for the user 110 to access the create array window 602.

FIGS. 3Q-3T depict a series of array layout screens 382 with image views 386 showing various stages of a DG design. The image views 386 may be displayed by selecting the “system design” category from the DG planning categories 326, the “array layout” tab from the design tabs 380, and the “design” tab from the array layout tabs 384. Along with each of the image views 386 shown in FIGS. 3Q-3T, a different set of design profiles are depicted in the design planning windows 388 for designing the potential DG 104.

In FIG. 3Q, the design planning window 388 depicts a plurality of roof face profiles, including a customizable profile. A selected roof face profile is displayed in the image view 386.

In FIG. 3R, the design planning window 388 displays a plurality of obstruction profiles that each depict a certain obstruction to the planned solar array, such as a chimney, satellite dish, or other object on the roof. In some embodiments, a customizable obstruction profile may be displayed. The user 110 may select one or more obstruction profiles and overlay the selected profiles on the roof face profile displayed in the image view 386.

In FIG. 3S, the design planning window 388 displays a plurality of shading profiles that each depict a predictable solar shading pattern, such shading that may occur on the roof due to a closely located tree. In some embodiments, a customizable shading profile may be displayed. The user 110 may select one or more shading profiles and overlay the selected profiles on the roof face profile displayed in the image view 386.

In FIG. 3T, the design planning window 388 displays a plurality of PV module placement profiles that each depict a relative size, shape, and orientation of a PV module. The size and shape of the PV module placement profiles may be automatically generated based on information entered in one or more of the display screens 300, such as the component selection screen 378. In some embodiments, a customizable PV module placement profile may be displayed. The user 110 may select one or more PV module placement profiles and design the PV module layout by overlay the selected profiles on the roof face profile displayed in the image view 386.

The array layout screens 382 thus provide a drawing tool, similar to a computer aided design (CAD) tool, for generating a customized DG system design that utilizes specific information and requirements (e.g., customer requirements, site-specific roof details, selected modules and racking, and the like) entered by the user 110 and/or automatically obtained, for example, via one or more of the display screens 300. In some embodiments, the DG management and planning system 108 may comprise an additional module for rendering a real-life image of the DG system design, for example, by utilizing actual images of the DG system components to be used and overlaying such DG component images onto an image of the potential DG site (e.g., a satellite image of the site, a photograph obtained during a site evaluation, map or hybrid imagery of the site, or a similar image of the site).

FIG. 3U depicts a budget calculator screen 392 that may be displayed by selecting the “system design” category from the DG planning categories 326 and the “budget” tab from the design tabs 380. The budget calculator screen 392 is an interface to the executable budget calculator module 240 that, when executed, provides the user 110 the ability to determine financial incentives and costs based on a design of a potential DG 104.

The budget calculator screen 392 displays a plurality of budget-related fields 391 for documenting information related to a budget for a potential DG 104. The budget-related fields 391 each comprise a drop-down menu for selecting budget information pertaining to the DG system design, such as price per watt, array size, rebate per watt, performance based incentive (PVI) per kilowatt hour, state tax credit, federal tax credit, and the like. Alternatively, the user 110 may enter information into one or more of the budget-related fields 391 by typing in data, importing data, or other data entry technique. The user 110 may save any of the entered data.

The budget calculator screen 392 additionally displays a list 393 of other financial incentives, such as gross costs, costs after rebate, net out of pocket costs, and the like.

The component selection screen 378, the array layout screen 382, and the budget calculator screen 392 allow the user 110 to design a potential DG 104.

FIG. 3V depicts a proposal screen 394 that may be displayed by selecting the “proposal” category from the DG planning categories 326. The proposal screen 394 is an interface to the executable proposal module 242 that, when executed, provides the user 110 the ability to generate a proposal for a potential DG 104.

The proposal screen 394 comprises the email field 367 and the “cc” field 371 for entering/displaying a first and a second email address, such as the customer's email address and any other pertinent email address, and the icon 369 for initiating an email of the DG proposal to be sent to the entered addresses. Additionally, the proposal screen 394 comprises a checklist display 395 for the user to select one or more items to include in the DG proposal, such as gross/rebate/investment tax credit (ITC)/net system cost, annual kilowatt hour production (PV watts), equipment specification, payment terms, schedule expectations, contractor warranty, system design, and the like. Based on the user-selected items in the checklist display 395, a customized proposal may be automatically generated utilizing information from one or more of the display screen 300.

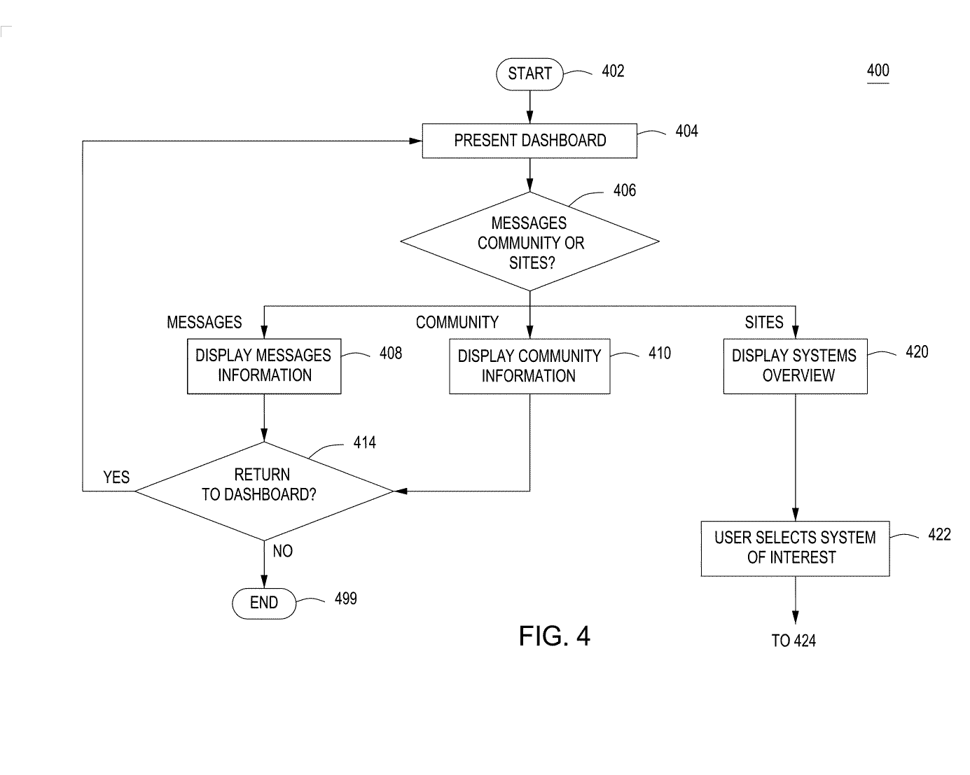

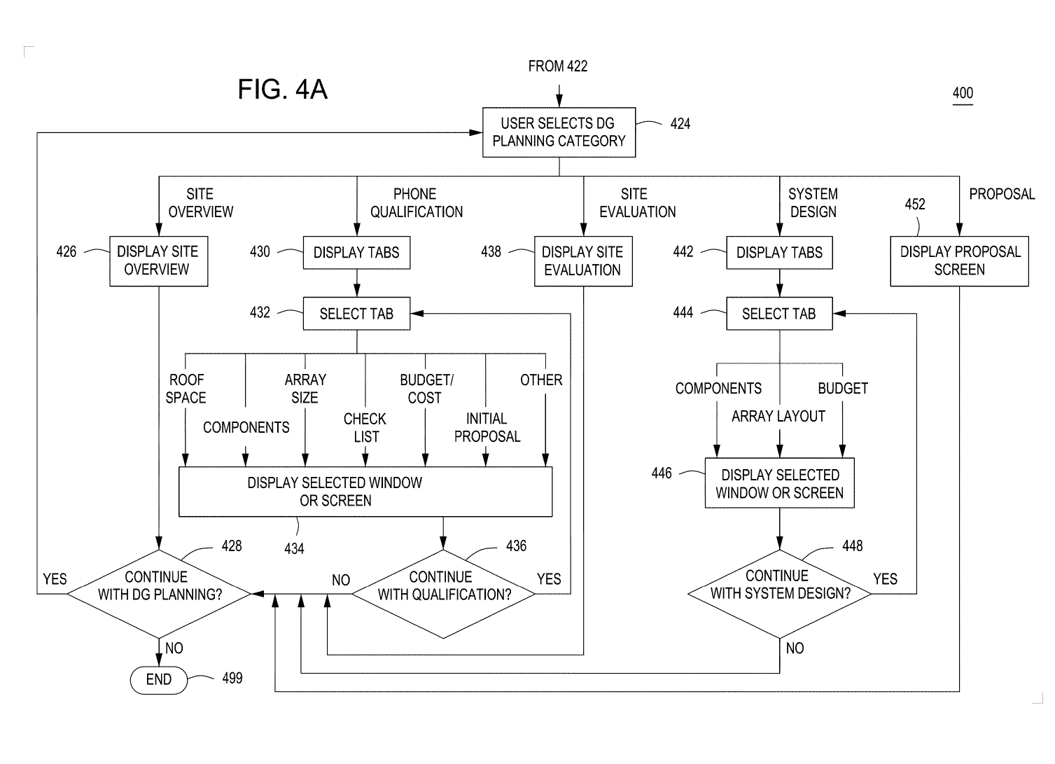

FIG. 4, which continues on FIG. 4A, is a flow diagram of a method 400 for planning a DG system in accordance with one or more embodiments of the present invention. The method 400 represents one embodiment of an implementation of the DG planning module 214. In some embodiments, a computer readable medium comprises a program that, when executed by a processor, performs at least a portion of the method 400 that is described in detail below.

The method 400 begins at step 402 and proceeds to step 404, where a dashboard screen, such as the dashboard screen 302, is displayed to a user. The dashboard screen provides an interface for the user to manage daily work tasks related to planning for potential DGs (such as DGs 104). In some embodiments, the dashboard screen may be displayed when the user logs into a website (e.g., a website that supports DG system planning) via a conventional web browser. The dashboard screen may additionally display information related to existing DG systems (for example, information as supported by the DG management module 214), although in some embodiments, such as the embodiment described with respect to FIG. 4, the dashboard screen is used for planning potential DGs.

The dashboard screen may comprise a plurality of windows for displaying various work areas, such as a message window for displaying alerts on issues requiring attention, information messages on news and resources, corporate happenings, and the like; a community window for displaying community-related information, such as links to peer-to-peer forums, links to social networking, and the like; and a sites window for displaying a summary of site statistics for existing and/or potential DGs, such as summaries of the number of DGs at each of a plurality of DG lifecycle stages (e.g., Stage 0—Lead, Stage 1—Design, Stage 2—Installation, Stage 3—Activation, and Stage 4—Monitor), summaries of the number of DGs experiencing events of various severities (e.g., high, medium, and low severities), and the like. In some alternative embodiments, the dashboard screen may display additional and/or alternative windows, such as a summary of metrics for providing a comparison of the user's average DG installation times versus average DG installation times of other employees.

The method 400 proceeds to step 406, where a user selects additional information to be displayed by selecting an icon, link, or the like, from the message window, the community window, or the sites window. If the user selects additional information from the messages window, the method 400 proceeds to step 408 where the desired message information is displayed, and then proceeds to step 414. If, at step 406, the user selects additional information from the community window, the method 400 proceeds to step 410 where the desired community information is displayed, and then proceeds to step 414. At step 414, the user selects whether to return to the dashboard screen or to end the current session; if the user selects to return to the dashboard screen the method 400 returns to step 404, while the method 400 proceeds to step 499 and ends if the user selects to end the current session.

If, at step 406, the user selects additional information from the sites window for potential DGs (i.e., information pertaining to the systems summary), the method 400 proceeds to step 420 where a systems overview window, such as the systems overview window 314, is displayed.

The systems overview window displays summary information pertaining to one or more potential DGs. The systems overview window may additionally display information related to existing DG systems (for example, information as supported by the DG management module 214), although in some embodiments, such as the embodiment described with respect to FIG. 4, the systems overview window is used for planning potential DGs. In some embodiments, the systems overview window displays an identification, such as a customer name and location, for each DG displayed, as well as a corresponding lifecycle stage and next step. Additionally, the systems overview window may display icons and/or links for one or more actions a user may take regarding a particular DG system displayed, such as an envelope icon for generating an email, a trash can icon for disposing of information, a clipboard icon for opening a document, a window icon for opening an additional window, and the like.

The method 400 proceeds to step 422, where the user selects a potential DG of interest from those listed in the systems overview window, such as a potential DG currently in a planning stage. The method 400 then proceeds to step 424, where the user selects a DG planning category from a plurality of DG planning categories displayed, such as site, phone qualification, site evaluation, system design, and proposal, to view a corresponding screen for planning the potential DG. If, at step 424, the user selects the “site” category, the method 400 proceeds to step 426, where a site overview screen, such as the site overview screen 324, is displayed for the potential DG.

The site overview screen displays high-level information pertaining to the selected DG. Such information may be displayed within a plurality of windows such as a lead details window, a satellite window, a PV goals window, and a notes window; in some embodiments, additional or alternative windows may be displayed.

The lead details window may display a plurality of fields that contain details pertaining to the selected DG, such as the customer's name, address, utility provider, phone contact, email contact, and electricity usage, as well as a lead source and a reminder regarding a timeframe for contacting the customer; in some embodiments, an automatic notification to the user may be triggered based on the timeframe in the reminder field. The user may enter new data into one or more of the displayed fiends, and/or one or more of the fields may be automatically populated with data previously stored in a system database. The user may enter or change data in any of the fields using well known data entry methods (e.g., manual entry, importing data, drop-down menus, and the like), and the user may save the data in the fields at any time.

The lead details window may additionally display a driving directions icon for linking to driving directions to the customer's location. In some embodiments, the driving directions may be pre-stored within a system database; alternatively, the driving directions may be obtained in real-time via existing Internet services, such as MAPQUEST.

The satellite window may display satellite imagery of the potential DG's location (e.g., as obtained from stored data or real-time via existing Internet sources, such as GOOGLE EARTH or MICROSOFT VIRTUAL EARTH). The satellite imagery may be automatically obtained based on data entered in one or more fields within the lead details screen, such as the address. The satellite window may display options for viewing the satellite imagery, such as selecting different views (e.g., north/south/east/west views), rotating a displayed view, zooming in or out of a displayed view, panning across a displayed view, or perform a similar operation. Additionally or alternatively, the satellite window may display map imagery and/or hybrid (satellite and map) imagery.

The notes window provides an interface for the user to document and save information pertaining to the potential DG (e.g., notes on discussions held with the customer, attempts to contact the customer, and the like). The PV goals window displays a plurality of attributes related to a DG (e.g., environmental, energy reduction, investment value, and aesthetic) and the priority of each attribute from the customer's perspective (e.g., low, medium, high).

The method 400 proceeds from step 426 to step 428, where a determination is made whether to continue with the DG planning. If the result of such determination is yes, the method 400 returns to step 424; if the result of such determination is no, the method 400 proceeds to step 499 where it ends.

If, at step 424, the user selects the “phone qualification” category from the DG planning categories, the method 400 proceeds to step 430, where a plurality of qualification tabs (such as qualification tabs 338) are displayed. The qualification tabs allow the user to select particular screens for use in the qualification of the potential DG. In some embodiments, the qualification tabs allow the user to select between a roof space screen (such as the roof space screen 336), an array size screen (such as the array size screen 346), a budget/cost screen (such as the budget cost screen 352), a components screen (such as the components screen 360), a checklist screen (such as the phone qualification checklist window 366), an initial proposal screen (such as the initial proposal window 370), or one or more other screens related to a potential DG phone qualification. Each of the aforementioned screens provides the user with the same information and functionality as previously described with respect to FIG. 3.

The method 400 proceeds to step 432, where the user selects one of the displayed qualification tabs; the method 400 then proceeds to step 434, where the selected screen is displayed for use by the user. The method 400 then proceeds to step 436, where a determination is made whether to continue with the qualification planning. If the result of such determination is yes, the method 400 returns to step 432 where the user may select other qualification tabs; if the result of such determination is no, the method 400 proceeds to step 428. At step 428, a determination is made whether to continue with the DG planning. If the result of such determination is yes, the method 400 returns to step 424; if the result of such determination is no, the method 400 proceeds to step 499 where it ends.

If, at step 424, the user selects the “site evaluation” category from the DG planning categories, the method 400 proceeds to step 438 where a site evaluation screen is displayed for use in planning and carrying out on on-site evaluation of a location for the potential DG system. The site evaluation screen provides the user with the same information and functionality as the site evaluation screen 372 previously described with respect to FIG. 3. The method 400 then proceeds to step 428, where a determination is made whether to continue with the DG planning. If the result of such determination is yes, the method 400 returns to step 424; if the result of such determination is no, the method 400 proceeds to step 499 where it ends.

If, at step 424, the user selects the “system design” category from the DG planning categories, the method 400 proceeds to step 442, where a plurality of system design tabs (such as the design tabs 380) are displayed. The system design tabs allow the user to select particular screens for use in the design of the potential DG. In some embodiments, the system design tabs allow the user to select between a components screen (such as the component selection screen 378), an array layout screen (such as the array layout screen 382), and a budget calculator screen (such as the budget calculator screen 392). Each of the aforementioned screens and windows provides the user with the same information and functionality as previously described with respect to FIG. 3.

The method 400 proceeds to step 444, where the user selects one of the displayed system design tabs; the method 400 then proceeds to step 446, where the selected screen is displayed for use by the user. The method 400 then proceeds to step 448, where a determination is made whether to continue with the DG system design. If the result of such determination is yes, the method 400 returns to step 444 where the user may select other system design tabs; if the result of such determination is no, the method 400 proceeds to step 428. At step 428, a determination is made whether to continue with the DG planning. If the result of such determination is yes, the method 400 returns to step 424; if the result of such determination is no, the method 400 proceeds to step 499 where it ends.

If, at step 424, the user selects the “proposal” category from the DG planning categories, the method 400 proceeds to step 452 where a proposal screen is displayed for generating a completed DG system proposal and sending the proposal to the customer. The proposal screen provides the user with the same information and functionality as the proposal screen 394 previously described with respect to FIG. 3. The method 400 then proceeds to step 428, where a determination is made whether to continue with the DG planning. If the result of such determination is yes, the method 400 returns to step 424; if the result of such determination is no, the method 400 proceeds to step 499 where it ends.

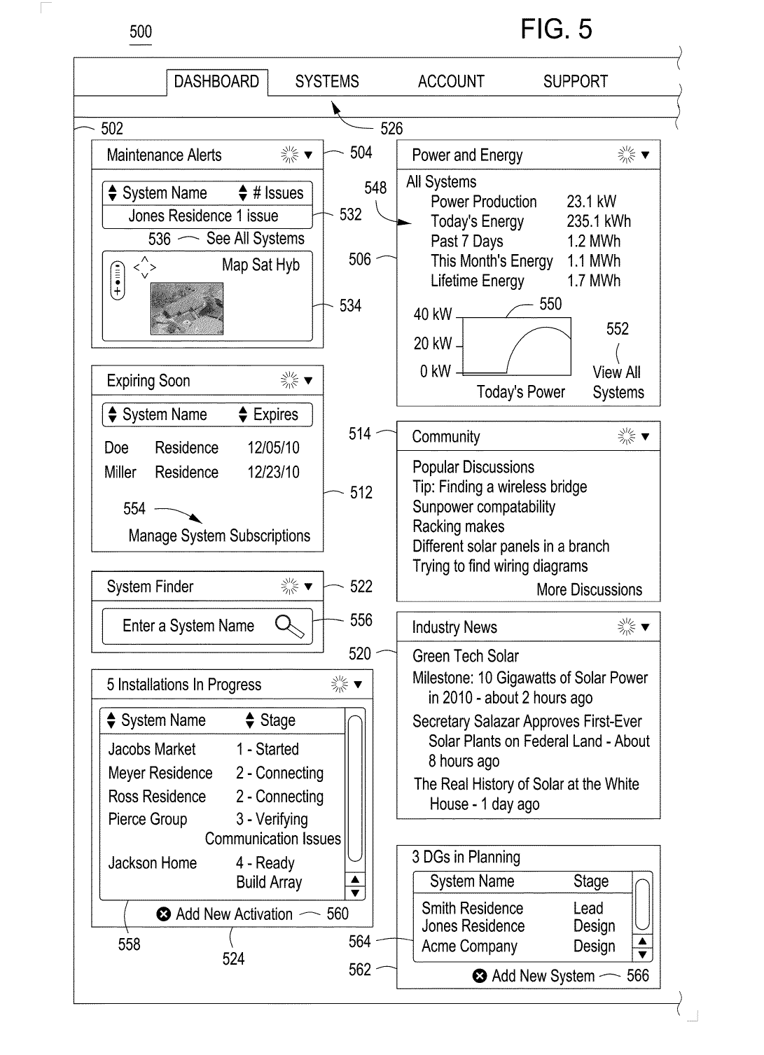

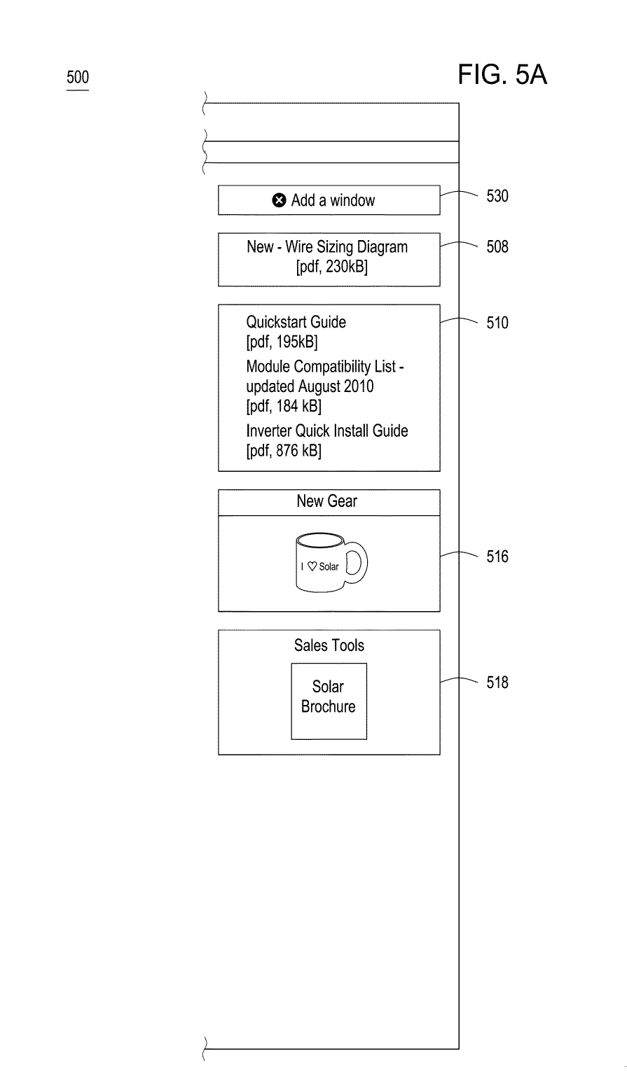

FIG. 5, which continues on FIG. 5A, depicts an alternative embodiment of a dashboard screen 502. The dashboard screen 502 may be displayed by clicking on a dashboard tab within a plurality of tabs 526 (e.g., dashboard, systems, account, support) displayed on the user's screen. The dashboard screen 502 comprises a maintenance alerts window 504, a power and energy window 506, a messages window 508, a relevant documents window 510, a systems expiration window 512, a community window 514, a new gear window 516, a sales tools window 518, an industry news window 520, a system finder window 522, an installations in progress window 524, and a DG planning in progress window 562. The dashboard screen 502 is an interface to the executable dashboard module 216 that, when executed, provides the user 110 the ability to manage daily work tasks. Some or all of the various windows within the dashboard screen 502 may be collapsed or expanded by clicking on a suitable icon, moved within the dashboard screen 502 (e.g., by clicking on and dragging the window), or deleted by the user 110. Additionally, the dashboard screen 502 comprises an icon 530 that can be clicked to add additional windows.

The maintenance alerts window 504 comprises a systems name window 532 for indicating any DG systems experiencing any maintenance alerts. The systems name window 532 indicates the name of the DG systems (e.g., “Jones Residence”) and the corresponding number of maintenance issues. The user 110 may click on a particular displayed system name or number of issues to receive additional corresponding information (e.g., details of the issues, details regarding the corresponding DG 102, and the like). The maintenance alerts window 504 further comprises a systems view window 534 that displays a view of one or more DG systems (e.g., a DG system experiencing a maintenance issue); for example, the user 110 may click on one of the system names in the systems name window 532 to display a view of the corresponding DG system. The systems view window 534 may display the one or more DG systems using satellite imagery (e.g., obtained from a satellite imagery source 116, such as GOOGLE EARTH or MICROSOFT VIRTUAL EARTH), map imagery (e.g., obtained from an Internet source such as YAHOO! MAPS or the like), and/or hybrid (satellite and map) imagery, for example as selected by the user 110.

The maintenance alerts window 504 further comprises an icon 536 to view a summary of DG systems.

The power and energy window 506 displays a summary of power and energy parameters and values for the existing DG systems 102, such as power production, today's energy, past seven days energy, this month's energy, and lifetime energy. In other embodiments, additional and/or alternative parameters may be utilized. The power and energy window 506 further displays a graph 550 depicting the summary of today's power for the existing DG systems 102; in other embodiments, the graph 550 may depict alternative power and energy parameters.

The power and energy window 506 further comprises an icon 552 that, when clicked, displays a systems summary window for the DG systems 102, for example by opening a new screen or window. The systems summary window may list the power and energy parameters and values displayed in the power and energy window 506 (e.g., power production, today's energy, past seven days energy, this month's energy, and lifetime energy) as a summary of all the existing DG systems 102. The systems summary window may further display a listing of each individual DG 102 as well as relevant parameters and values for each system, such as system name, location, current power, lifetime energy, status (normal status, issues exist, and the like), and the like. The systems summary window may further display one or more maps for the DGs 102 (e.g., satellite imagery, map imagery, or hybrid imagery) or for one or more selected DGs 102.

The power and energy window 506 may also be customized to display a summary of power and energy parameters and values for one or more particular DG systems 102 (i.e., a customized DG group). For example, the systems summary window may comprise an icon for the user 110 to create and manage groups of one or more DGs 102. Upon clicking the icon, a window may open comprising an icon to add a new group. By clicking the icon to add a new group, the user may be presented with a list of existing DGs 102 and a name field to enter a name for the group. The user may create the group by clicking on the desired DG or DGs and may save the created group (e.g., by clicking on a save icon). The user 110 may be able to create multiple groups and name each group, and may be able to add additional DGs to or remove DGs from existing groups. The user 110 may then be able to select, for example from a drop-down menu within the power and energy window 506, either all systems or a particular group for display in the power and every window 506.

The messages window 508 displays messages for the user 110; for example, the messages window 508 may display a new message regarding a wire sizing diagram. The user 110 may click on a displayed message to receive additional details regarding the message.

The relevant documents window 510 displays links to any relevant documentation pertaining to DG systems, such as quick-start guides, module compatibility lists, quick-install guides, and the like. The user 110 may click on a displayed document to view the document, download the document, or perform a similar function.

The systems expiration window 512 displays a list of DG systems 102 for which the system subscription (e.g., maintenance subscriptions, monitoring subscriptions, or the like) is due to expire within a certain period of time. Such a period of time may be pre-defined and/or customizable by the user 110. The systems expiration window 512 lists each relevant DG 102 (e.g., the name of the DG 102) and the date of expiration. The systems expiration window 512 further comprises an icon 554 which, when clicked, allows the user 110 to manage DG system subscriptions. For example, clicking on the icon 554 may open one or more windows and/or redirect the user 110 to provide information and functions to manage corresponding to the DG system subscriptions, such as changing or renewing a subscription (e.g., by entering credit card information).

The community window 514 displays information pertaining to relevant issues for the work community of the user 110. For example, the community window 514 may displays links pertaining to tips articles or discussions on securing a wireless bridge, component compatibility, rack manufacturers, using different solar panels in a DG, finding wiring diagrams, or the like.

The new gear window 516 displays new merchandise available for purchase, for example via a website for the user's company. In some embodiments, the user 110 may click on the new gear window 516 or a display within the window to make a purchase or be redirected to the company's online store.

The sales tools window 518 displays one or more sales tools. The user 110 may click on the sales tools window 518 or a sales tool displayed within the window to receive additional information on a particular sales tool.

The industry news window 520 lists relevant news items pertaining to DG systems, such as links to online news articles or the like. The user 110 may click on a listed news item to receive more information on the news item; for example, the user 110 may be redirected to a corresponding online article. The industry news window 520 may comprise a drop-down menu for the user 110 to select one or more sources of news articles.

The system finder window 522 provides a field 556 for the user 110 to enter at least a portion of the name for a particular DG 102 for obtaining information related to the DG 102 (e.g., system topology, current power production levels, operational status, historical information, graphical depiction of power production per PV module, and the like). For example, one or more additional windows may be opened to display information pertaining to the DG 102, the user 110 may be redirected to a site for the DG 102, or a similar function may be performed.

The installations in progress window 524 comprises a scroll-down window 558 listing those DGs 102 that are in the process of being installed and turned up for operation. The scroll-down window 558 lists the names of the relevant DGs 102 and their corresponding stage (e.g., started, connecting, verifying, ready, or the like). The user 110 may click on any of the listed DGs 102 to receive additional information pertaining to the DG 102 and its current stage. The scroll-down window 558 may also display an indication of any current issues for each of the listed DGs 102, and the user 110 may obtain additional information by clicking on a displayed issue. The installations in progress window 524 may additionally comprise an icon 560 that, when clicked, allows the user 110 to add additional DGs 102. The installations in progress window 524 indicates the number of DGs 102 currently being installed and turned up for operation, e.g., in a header for the window.

The DG planning in progress window 562 comprises a scroll-down window 564 listing the DGs 104; i.e., those DGs that are currently in a planning phase. Such a planning phase may range from an earliest indication of a sales lead for a DG system through a final DG system proposal made to a customer and a subsequent signed contract for the DG system. The scroll-down window 564 lists the names of the DGs 104 and their corresponding stage (e.g., lead, design, contract, or the like). The user 110 may click on any of the listed DGs 104 to receive additional information pertaining to the DG 104 and its current stage. The scroll-down window 564 may also display an indication of any current issues for each of the listed DGs 104, and the user 110 may obtain additional information by clicking on a displayed issue. The DG planning in progress window 562 may additionally comprise an icon 566 that, when clicked, allows the user 110 to add new DGs 104. The DG planning in progress 524 indicates the number of DGs 104, e.g., in a header for the window.

In some embodiments, the dashboard screen 502 comprises a subset of the windows described above.

FIG. 6 depicts one embodiment of a create array window 602. The create array window 602 may be displayed when the user 110 selects a corresponding icon from the roof space screen 336 (e.g., within the mockup planning window 344), the array layout screen 382 (e.g., the design planning window 388), or from another of the screens 300. Alternatively, the DG planning categories 326, the qualification tabs 338, and/or the design tabs 380 may comprise a category or tab for selecting the create array window 602, and the create array window 602 may be an interface to the executable create array module 252 that, when executed, provides the user 110 the ability to create an array design for the DG 104.

The create array window 602 allows the user 110 create an array design, for example, in a FLASH-based, visual, drag-and-drop interface. The create array window 602 comprises an orientation section 604, a shape section 606, an azimuth section 608, and an array name section 610. The orientation section 604 allows the user 110 to select an orientation for the PV modules for the array design by selecting from a depicted horizontally orientated rectangle or a depicted vertically oriented rectangle. As depicted in FIG. 6, the horizontal orientation has been selected by clicking on the marker next to the horizontally oriented rectangle.

The shape section 606 comprises a row field 610 and a column field 612 for entering a number of rows and columns, respectively, for the array design. For example, the user 110 may enter “2” into the row field 610 and “3” into the column field. The shape section 606 displays an array design 614 based on the selected PV module orientation and the number of entered rows/columns, for example a rectangular shaped array comprising two rows and three columns of horizontally oriented PV modules as depicted in FIG. 6.

The azimuth section 610 comprises an azimuth field for entering the azimuth of the array (i.e., the position of the array as it relates to true north). The array name section 610 comprises a name field for the user 110 to enter a name for the array, and a create array icon 622 that, when clicked, creates an array design utilizing the entered information.

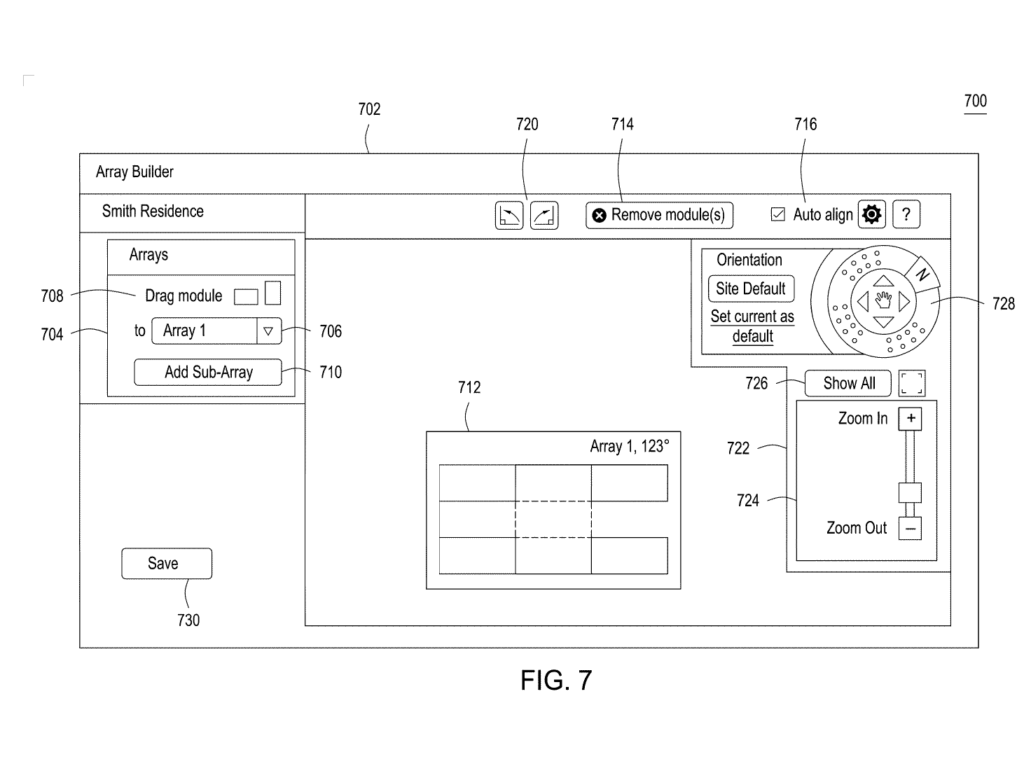

FIG. 7 depicts one embodiment of an array builder window 702. The array builder window 702 may be displayed when the user 110 clicks the create array icon 622. The array builder window 702 allows the user 110 to create complex array shapes, such as pyramids, brick patterns, and the like by adding, moving, and/or removing PV modules in an array design (e.g., an array design created via the create array window 602) and to perform various modifications of an array design, for example, in a FLASH-based, visual, drag-and-drop interface.

The array builder window 702 comprises an array modification section 704 that allows the user 110 to modify an array within an array design (which also may be referred to as a sub-array), such as an array 712. The array 712 may be surrounded by a “bounding box” (e.g., a dashed box or solid frame) for indicating the boundaries of the array 712. The array modification section 704 comprises a drop-down menu 706 for the user 110 that displays one or more array names for the user 110 to select a particular array; alternatively, the array 712 may be selected by clicking on the border of the array 712.

Upon selection, the array 712 is presented in a head-on view. The user 110 may delete one or more PV modules from the array 712 (e.g., by clicking on a module followed by a remove module icon 714). The user 110 may move one or more PV modules in the array 712 and/or the entire array 712 (e.g., by clicking on a module or the array 712 and dragging the selected item). The array builder window 702 may indicate overlapping modules within the array 712, for example by highlighting the overlapping modules. The user 110 may activate an auto align function (e.g., by clicking on an auto align icon 716) that automatically aligns PV modules within the array 712.

The array modification section 704 further comprises add module icons 708 for the user 110 to add horizontally and/or vertically oriented PV modules to the array 712 (e.g., by clicking on a displayed horizontally oriented rectangle or a vertically oriented rectangle and dragging the selected rectangle on the screen). Module orientation within the array 712 may be changed by clicking an orientation icon 720 to rotate a selected module 90° clockwise or counterclockwise. The array modification section 704 further comprises an add sub-array icon 710 for the user 110 to add another array to the array design (e.g., clicking the add sub-array icon 710 may display the create array window 602). The user 110 may delete an array from an array design, for example by clicking on the array followed by a remove array icon.

The array builder window 702 further displays a navigation feature 722 for navigating around an array design. The navigation feature 722 comprises a zoom feature 724 to zoom in or out of the array 712, a show all icon 726 for viewing a global view of an array design, and a compass feature 728 for stepping across an array design (e.g., by clicking navigation arrows on the compass feature 728) or reorienting the array 712 (e.g., by clicking a rotate wheel on the navigation feature 722).

The user 110 may also edit the name and/or azimuth of the array 712, for example by clicking on the array name within the drop-down menu 706 and editing corresponding array name and azimuth fields subsequently displayed. The user 110 may save any changes to an array design by clicking a save icon 730.

The array builder window 702 may comprise additional features for creating and/or modifying an array design.

While the foregoing is directed to embodiments of the present invention, other and further embodiments of the invention may be devised without departing from the basic scope thereof, and the scope thereof is determined by the claims that follow.

1. An apparatus for distributed generator (DG) planning, deployment, and operation comprising:
a computing system, comprising at least one processor, for generating a plurality of different user-interactive interfaces for visually depicting a plurality of DG lifecycle stages of at least one DG, wherein each user-interactive interface of the plurality of different user-interactive interfaces respectively displays manipulatable information regarding:
A) managing a sales lead for a potential DG;
B) designing the potential DG;
C) managing installation information for installation of a DG based on the potential DG;
D) activating, following completion of the installation of the DG, the DG; and
E) monitoring and displaying at least one performance characteristic of the DG; wherein each user-interactive interface of the plurality of different user-interactive interfaces is selectable from a dashboard to display the manipulatable information related to each DG lifecycle stage in the plurality of DG lifecycle stages.

2. The apparatus of claim 1, wherein designing the potential DG comprises sizing the potential DG, designing a layout for the potential DG, and generating a proposal for the potential DG.

3. The apparatus of claim 1, wherein the plurality of different user-interactive interfaces comprises at least one user-interactive interface for assessing usable space for installing the potential DG and that utilizes satellite imagery of a location of the potential DG.

4. The apparatus of claim 1, wherein the plurality of different user-interactive interfaces comprises at least one user-interactive interface for determining a size of the potential DG to offset a percentage of commercial power usage.

5. The apparatus of claim 1, wherein the plurality of different user-interactive interfaces comprises at least one user-interactive interface for selecting manufacturer-specific components of the potential DG.

6. The apparatus of claim 1, wherein the plurality of different user-interactive interfaces comprises at least one user-interactive interface for displaying selectable profile images for designing an array layout, wherein the selectable profile images are from images comprising: roof face profile images, obstruction profile images, shading profile images, and module placement profile images.

7. The apparatus of claim 1, wherein the plurality of different user-interactive interfaces comprises at least one user-interactive interface for determining financial incentives and costs of the potential DG based on a design of the potential DG.

8. The apparatus of claim 2, wherein the plurality of different user-interactive interfaces comprises at least one user-interactive interface for generating the proposal by selecting, to be included in the proposal, at least one of a system cost, an annual system power production, an equipment specification, payment terms, a schedule, a warranty, or a system design.

9. The apparatus of claim 8, wherein the plurality of different user-interactive interfaces comprises at least one user-interactive interface for automatically sending the proposal, via email, to a customer associated with the potential DG.

10. A method for distributed generator (DG) planning, deployment, and operation, at least a portion of the method being performed by a computer system comprising at least one processor that generates a plurality of different user-interactive interfaces for visually depicting a plurality of DG lifecycle stages of at least one DG, the method comprising:
A) managing a sales lead for a potential DG;
B) designing the potential DG;
C) managing installation information for installation of a DG based on the potential DG;
D) activating, following completion of the installation of the DG, the DG; and
E) monitoring and displaying at least one performance characteristic of the DG; wherein each user-interactive interface of the plurality of different user-interactive interfaces is selectable from a dashboard to display manipulatable information related to each DG lifecycle stage in the plurality of DG lifecycle stages.

11. The method of claim 10, wherein generating a design for the potential DG comprises sizing the potential DG, designing a layout for the potential DG, and generating a proposal for the potential DG.

12. The method of claim 10, wherein the plurality of different user-interactive interfaces comprises at least one user-interactive interface for assessing usable space for installing the potential DG and that utilizes satellite imagery of a location of the potential DG.

13. The method of claim 10, wherein the plurality of different user-interactive interfaces comprises at least one user-interactive interface for determining a size of the potential DG to offset a percentage of commercial power usage.

14. The method of claim 10, wherein the plurality of different user-interactive interfaces comprises at least one user-interactive interface for selecting manufacturer-specific components of the potential DG.

15. The method of claim 10, wherein the plurality of different user-interactive interfaces comprises at least one user-interactive interface for displaying selectable profile images for designing an array layout, wherein the selectable profile images are from images comprising: roof face profile images, obstruction profile images, shading profile images, and module placement profile images.

16. The method of claim 10, wherein the plurality of different user-interactive interfaces comprises at least one user-interactive interface for determining financial incentives and costs of the potential DG based on a design of the potential DG.

17. The method of claim 11, wherein the plurality of different user-interactive interfaces comprises at least one user-interactive interface for generating the proposal by selecting, to be included in the proposal, at least one of a system cost, an annual system power production, an equipment specification, payment terms, a schedule, a warranty, or a system design.

18. The method of claim 17, wherein the plurality of different user-interactive interfaces comprises at least one user-interactive interface for automatically sending the proposal, via email, to a customer associated with the potential DG.

19. A non-transitory computer readable medium comprising a program that, when executed by a processor, generates a plurality of different user-interactive interfaces for visually depicting a plurality of DG lifecycle stages of at least one DG, each user-interactive interface of the plurality of different user-interactive interfaces respectively displaying manipulatable information regarding:
A) managing a sales lead for a potential DG;
B) designing the potential DG;
C) managing installation information for installation of a DG based on the potential DG;
D) activating, following completion of the installation of the DG, the DG; and
E) monitoring and displaying at least one performance characteristic of the DG; wherein each user-interactive interface of the plurality of different user-interactive interfaces is selectable from a dashboard to display the manipulatable information related to each DG lifecycle stage in the plurality of DG lifecycle stages.

20. The non-transitory computer readable medium of claim 19, wherein the plurality of different user-interactive interfaces comprises at least one user-interactive interface for each of (i) assessing usable space for installing the potential DG; (ii) determining a size of the potential DG to offset a percentage of commercial power usage; (iii) selecting manufacturer-specific components of the potential DG; (iv) displaying selectable profile images for designing an array layout; (v) determining financial incentives and costs of the potential DG based on a design of the potential DG; (vi) generating a proposal for the potential DG by selecting, to be included in the proposal, at least one of a system cost, an annual system power production, an equipment specification, payment terms, a schedule, a warranty, or a system design; and (vii) automatically sending the proposal, via email, to a customer associated with the potential DG.
